(19) United States
(12) Patent Application Publication
(10) Pub. No.: US 2026/0163672 A1
(43) Pub. Date: Jun. 11, 2026

(54) TECHNIQUES FOR SWEEP WIDE AREA MODULATION OF INFORMATION BITS

(71) Applicant: Silicon Laboratories Inc., Austin, TX (US)

(72) Inventor: Fabrice Christophe Olivier Portier, Cesson-Sévigné (FR)

(21) Appl. No.: 19/226,452

(22) Filed: Jun. 3, 2025

Related U.S. Application Data
(63) Continuation-in-part of application No. 18/193,667, filed on Mar. 31, 2023, now Pat. No. 12,375,330.
(60) Provisional application No. 63/788,516, filed on Apr. 14, 2025.

(51) Int. Cl. H04L 1/00; H04L 27/26

(52) U.S. Cl. CPC H04L 1/0042; H04L 1/0003; H04L 27/2697

(57) ABSTRACT

In an embodiment, a method includes: modulating, in a modulator of a transmitter, a symbol having at least one information bit, comprising performing at least one operation on a sequence, the sequence based, at least in part, on at least one of range information or group information of a plurality of information parameters; extending, in a circuit of the transmitter coupled to the modulator, the sequence to obtain a plurality of modulated symbols; performing, in the circuit, at least one additional operation on the plurality of modulated symbols according to a Recipe of operations, to obtain extended and modulated symbols; and transmitting, via a radio frequency (RF) front end circuit of the transmitter coupled to the circuit, the extended and modulated symbols.

### CROSS-REFERENCE TO RELATED APPLICATION

The present application is a Continuation-In-Part of U.S. application Ser. No. 18/193,667, filed Mar. 31, 2023, entitled “TECHNIQUES FOR ROBUST WIDE AREA MODULATION,” and also claims the benefit of U.S. Provisional Application No. 63/788,516, filed on Apr. 14, 2025, entitled “TECHNIQUES FOR SWEEP WIDE AREA MODULATION OF INFORMATION BITS.”

### BACKGROUND

Efficient information transmission in communication systems requires careful use of available resources, ensuring energy is well-distributed across the allocated bandwidth and time. For low-cost, low-power transceivers, it is desirable that transmitted packets maintain moderate bandwidth, exhibit minimal power fluctuations (i.e., low Peak-to-Average Power Ratio (PAPR)), good waveform shaping, and remain easy to modulate and to detect/synchronize/demodulate, even under low Signal-to-Interference-plus-Noise Ratio (SINR) conditions across diverse scenarios. However, many existing systems lack scalability and rely on rigid trade-offs or worst-case design assumptions, which can lead to increased complexity, higher power consumption, and inefficient resource usage, ultimately degrading overall wireless network performance in real-world environments.

### SUMMARY OF THE INVENTION

In one aspect, an apparatus includes: an encoder to encode at least one information bit into a symbol of a packet; and a modulator coupled to the encoder. The modulator is to: apply at least one operation on a sequence to modulate the at least one information bit of the symbol, the sequence based, at least in part, on at least one of range information or group information of a plurality of information parameters. The apparatus further includes a circuit coupled to the modulator, the circuit to: extend the sequence to obtain at least one modulated symbol; and perform, on the at least one modulated symbol, at least one additional operation according to a Recipe of operations, to obtain at least one extended and modulated symbol. The apparatus also includes a radio frequency (RF) front end circuit coupled to the circuit to process and transmit the at least one extended and modulated symbol.

In one implementation, the circuit is perform, on the at least one modulated symbol comprising a plurality of modulated symbols, the at least one additional operation according to the Recipe of operations based, at least in part, on the group information of the plurality of information parameters.

In an implementation, the modulator is to modulate at least a first bit of the at least one information bit in at least one of a parameter of the sequence or a frequency offset of the sequence. The apparatus may further include a controller to select the frequency offset based on the at least first bit. The controller is to select the frequency offset from N frequency offsets, the at least first bit comprising log₂(N) bits. The apparatus may further comprise a controller to select the direction of the slope based on the at least first bit and to select the frequency offset based on one or more other bits of the at least one information bit.

In an implementation, the apparatus further comprises a controller to determine the Recipe of operations based, at least in part, on at least one of packet interference mitigation information or the group information of the plurality of information parameters. The circuit may perform, on the at least one modulated symbol comprising a plurality of modulated symbols, the at least one additional operation comprising a combination of one or more of: a complex conjugate operation; a time reversal operation; a phase shift operation; a frequency shift operation; a circular time shift operation; a slope operation; or a null operation.

In another aspect, an apparatus includes a circuit to: receive a symbol having at least one information bit; encode at least a first bit of the at least one information bit in at least one of a direction of a slope of a sequence or a frequency offset of the sequence; and perform, on the sequence, at least one operation according to a Recipe of operations, to obtain at least one modulated symbol. The apparatus may further include a RF front end circuit coupled to the circuit to process and transmit the extended and modulated symbols.

In an implementation, the apparatus further comprises a controller coupled to the circuit, and the controller is to select the frequency offset based on the at least first bit. The controller is to select the frequency offset from N frequency offsets, the at least first bit comprising log₂(N) bits. The controller is to select the direction of the slope based on the first bit. The controller may be configured to determine the Recipe of operations based at least in part on at least one of packet interference mitigation information or group information of a plurality of information parameters.

In an implementation, the circuit is to extend the sequence to obtain a plurality of modulated symbols, and perform, on the plurality of modulated symbols, the at least one operation according to the Recipe of operations based, at least in part, on range information of a plurality of information parameters.

In an implementation, the circuit is to extend the sequence to obtain a plurality of modulated symbols, and perform, on the plurality of modulated symbols, the at least one operation according to the Recipe of operations based, at least in part, on at least one of packet interference mitigation information or group information of a plurality of information parameters. The circuit may be configured to perform, on the plurality of modulated symbols, the at least one operation comprising a frequency shift between a first one of the plurality of modulated symbols and a second one of the plurality of modulated symbols.

In an implementation, the Recipe of operations comprises at least one of: a complex conjugate of at least one of the plurality of modulated symbols; a phase operation on at least one of the plurality of modulated symbols; a frequency shift of at least one of the plurality of modulated symbols; a reversal of at least one of the plurality of modulated symbols; or a null operation.

In yet another aspect, a method includes: modulating, in a modulator of a transmitter, a symbol having at least one information bit, comprising performing at least one operation on a sequence, the sequence based, at least in part, on at least one of range information or group information of a plurality of information parameters; extending, in a circuit of the transmitter coupled to the modulator, the sequence to obtain a plurality of modulated symbols; performing, in the circuit, at least one additional operation on the plurality of modulated symbols according to a Recipe of operations, to obtain extended and modulated symbols; and transmitting, via a RF front end circuit of the transmitter coupled to the circuit, the extended and modulated symbols.

In an implementation, the method further comprises modulating at least a first bit of the at least one information bit in at least one of a direction of a slope of the sequence or a frequency offset of the sequence. Modulating the symbol further comprises scrambling the symbol using a first scrambling seed, and the method further comprises: modulating, in the modulator, the symbol scrambled using a second scrambling seed, comprising performing the at least one operation on a second sequence; extending, in the circuit, the second sequence to obtain a second plurality of modulated symbols; performing, in the circuit, the at least one additional operation on the second plurality of modulated symbols according to the Recipe of operations, to obtain second extended and modulated symbols; and transmitting, via the RF front end circuit, the second extended and modulated symbols, to provide a retransmission of the symbol.

### BRIEF DESCRIPTION OF THE DRAWINGS

FIG. 1 is a block diagram of a transmitter in accordance with an embodiment.

FIG. 2A is a flow diagram of a method in accordance with an embodiment.

FIG. 2B shows example sweep sequences and graphical illustrations in accordance with an embodiment.

FIG. 2C shows example symbol modulated and extended illustrations in accordance with an embodiment.

FIG. 3 is a block diagram of a more detailed implementation of a transmitter in accordance with an embodiment.

FIG. 4 is a block diagram illustrating representative frames in accordance with an embodiment.

FIG. 5 is a block diagram of a receiver in accordance with an embodiment.

FIG. 6 is a flow diagram of a method in accordance with another embodiment.

FIG. 7 is a timing diagram illustrating modulation of information bits in accordance with another embodiment.

FIG. 8 is a flow diagram of a method in accordance with another embodiment.

FIG. 9 is a flow diagram of a method in accordance with yet another embodiment.

FIGS. 10A-D are examples of a signal generated with a M2 modulation in accordance with an embodiment.

FIG. 11 is a block diagram of a representative integrated circuit that includes transceiver circuitry to perform SWAM modulation and/or demodulation.

FIG. 12 is a high-level diagram of a network in accordance with an embodiment.

### DETAILED DESCRIPTION

In various embodiments, a transmitter is configured to perform modulation of communications for long-range scenarios. Although embodiments are not limited in this regard, as an example a transmitter can be configured to dynamically control modulation aspects to enable transmission of wireless signals over relatively long ranges, e.g., of up to approximately a few tens or hundreds of kilometers.

In embodiments, Constant Amplitude, and in particular Constant Amplitude Zero Auto-Correlation (CAZAC), sequences may be used to perform modulation. In general, a CAZAC sequence is a polyphase sequence having periodic complex-valued signals with a modulus of one and out-of-phase periodic (cyclic) auto-correlations equal to zero. In an embodiment, an example for construction of such signal sequences may be a combination of well-chosen quasi-CAZAC sequences and Orthogonal Frequency Division Multiplexing (OFDM) principles. The chosen CAZAC sequences may be close to Zadoff-Chu (ZC) sequences, or more generally Generalized Chirp Sequences (GCS). Such a GCS-precoded or ZC-precoded OFDM signal can be used as a basis to define a modulation scheme robust for long-range scenarios. These sequences may optionally be transformed into another domain using Fourier Transforms (Discrete Fourier Transform (DFT) or Fast Fourier Transform (FFT) processing) of OFDM systems, with potential further signal processing to shape the signal (e.g., windowing, filtering, power compression), to provide desired properties. Such sequences are referred to herein as Sweep-Sequences (SS), or more generally “sequences” and may be formed of tens to thousands of complex-valued samples.

A Generalized Chirp sequence (GCS) of complex samples, of length N_{zc} and parameters (P,Q,U,S), could be defined with the following equation:

$${S}_{G C S ( Nzc , P , Q , U , S )} [ n ] = exp ( j ( P + \frac{2 π}{{N}_{z c}} \frac{Q}{2} n + \frac{2 π}{{N}_{z c}} \frac{U}{2} {n}^{2} + \frac{2 π}{{N}_{z c}} \frac{S}{2} {n}^{3} ) ) , 0 \leq n \leq Nzc - 1$$

where P, Q, U, S do not need to be integers.

As a subset, a root Zadoff-Chu sequence of complex samples, of length N_{zc} and root u, with potential cyclic shift q is defined with the following equation: S_{zc(Nzc,u)}[n]=exp(−j·π·n·(u(n+c)+2q)/N_{zc}), 0≤n<N_{zc}, where c is generally 0 for even N_{zc} and 1 for default odd N_{zc} (ensures cyclicity/continuity if repeated); u is an integer identifying the ZC sequence, called a root index. ZC is a particular case of GCS with S=0, P=0, integer u=−U, q=−Q/2 when N_{zc} is even, and q=−(Q/2+U/2) when N_{zc} is odd.

These ZC are polyphase sequences with perfect periodic auto-correlation function (i.e., complex sequences with unit amplitude and null auto-correlation for all cyclic shifts except zero). However, compromises considering pool of sequences with low shifted auto-correlation and low inter-correlations could be sufficient for a given application.

OFDM (I)DFT conversion for N_{f} complex samples is in accordance with the following equation:

$$X [ k ] = \frac{1}{\sqrt{{N}_{f}}} {\sum }_{n = 0}^{{N}_{f} - 1} x [ n ] \cdot exp ( \pm j \cdot 2 π \cdot n \cdot k / {N}_{f} ) , 0 \leq k \leq {N}_{f} - 1.$$

DFT (or FFT) processing ensures signal continuity at sequence edges, and also allows resampling (final SS bandwidth can differ from initial/sampling bandwidth, filling edge FFT bins with zeros, e.g., when Nf>Nzc).

ZC-OFDM is the combination of these two processing functions, with potential intermediate- and/or post-processing to shape the signal (e.g., centering, filtering, windowing, shifting, compressing in power). After the selection of sizes (N_{zc}, N_{fft}=N_{f}·L) and sampling rates (that also define the SS bandwidth and duration), there can be several imaginable sequences that are quasi-orthogonal (up to Nzc for ZC-OFDM with integer u) or with limited correlations. Note that sequences can be L-oversampled to further improve the signal shaping and properties (e.g., finer tuning/filtering and management of PAPR/Out of Band (OoB) using higher FFT of length N_{fft}=N_{f}L instead of N_{fft}=N_{f}≥N_{zc}).

As another subset of GCS with U=0 and S=0, ultra-narrow-band simple carriers (constant frequency per block) sequences or hopping single-carrier sequences are also particular cases with low PAPR and some capabilities to provide several orthogonal sequences (or semi-orthogonal once different coding/hopping and/or Recipe of operations are applied for each user), e.g., for different values of even Q in [0, . . . N_{zc}] in the GCS equation above. Piecewise-non-sweeping ultra-narrow-band sequences may appear less robust, for a given SS, than the presented CAZAC sequences regarding some noises and interferences, but robustness and good use of the allocated spectrum can be recovered from the Recipes described later in this document. Then, hopping subcarriers (piecewise pure sinusoids) to design a list of sequences is also a low-rate solution to share a scarce resource, and is equivalent to precoded-OFDM with the precoding vector of size Not being all zeros except one element at once (1 complex value on the unit circle). However, a general receiver for that case may need different algorithms with potential higher complexity to demodulate or synchronize, just as less optimal spectrum (and potential dependency on filtering processes) compared to ZC and ZC-OFDM sequences. Moreover, presenting a different spread of energy over time, depending on the considered averaging periods to compute the spectrums, solutions that are more ‘peaky in frequency’ could be more restricted in power by regulations to access some wireless channels/bands.

As another intermediate example list of sequences, a subset of GCS with low sweeping slopes (non-integer 0<|U|<1 and/or more zeros on edges in a following OFDM FFT) and S=0, can provide sweeping sequences with low PAPR and capabilities to provide several orthogonal sequences (or weakly correlated) with another balance on robustness to interferences in time/frequency, number of simultaneous packets on the same band, and management of Groups. The related spectrum per SS does not spread the energy as equally as GCS/ZC-based sequences with integer U≥1, but the description of Recipes in next processing stages will allow to further spread properly the signal over the whole system bandwidth, while still allowing simplified receiver processing of sweeping sequences in real channels (with multipath interference). Simple receivers with robustness to any noise, including localized interferers ‘peaky-in-frequency’ and ‘peaky-in-time’, are possible with weighted aggregation of such blocks from the modulation. Then, from presented equations and solutions, users in the field can readily adjust parameters and durations to meet the requirements and regulations.

In one or more embodiments, a transmitter may generate and/or store a pool of such sequences. These sequences may be particularly optimized for long range wireless communications, with particular properties including the following. The sequences may enable good shapes in time and frequency that are better than generic (worst-case) OFDM, having low power variations over time (low PAPR), and good shaping in frequency (aiming ideal spectrum for the application, with low Out-of-Band emissions), as presented above. These sequences may further have good auto-correlation and cross-correlations figures, i.e., localized auto-correlation (almost null except for zero-shift auto-correlation).

Collectively, the list of sequences can be rather orthogonal (i.e., with low correlations with any shift among the list) to efficiently identify a given SS and its shift. Further optimizations with the selected modulation may include continuity when repeated (ZC, ZC-OFDM, and any precoded-OFDM sequence are already circular/continuous sequences); low impact when modulated (reduced edge effects like discontinuities involving out-of-band emissions, modified PAPR and lost power); and simple demodulation solutions (either in frequency or time domain, generally based on frequency-sweep-like properties, and/or symmetries).

Note that ZC values are naturally quasi-orthogonal when considering different integer root values u, and a couple of sequences with values of u generally corresponding to low sweeps (e.g., {1,2,3}) per block may offer good trade-offs with rather low PAPR once frequency-transformed. Note that the DFT of a ZC sequence, with N_{zc} prime, is still a ZC sequence (keep constant amplitude with good correlation properties), while there is no intermediate processing.

Several properties like symmetries/repetitions can exist among sequences (e.g., the conjugate of a sequence is generally its reversed-ordered version when sequences are anti-symmetric, generally representing a frequency sweep in the other direction and u′=N_{zc}−u) and could also save memory. These sequences are often close to frequency-sweep sequences (CSS could be seen as a particular case of ZC-OFDM with the simplest sweep over the full N_{zc}=N_{fft}, with u=1 and without windowing), i.e., could approach one or several tones sweeping (less than one, one or several times) on the allocated area (given bandwidth and sequence duration).

Using such a SS as a basis, a Symbol Modulated and Extended (SME) can be generated to efficiently transmit information. SME is the combination of a modulation of the SS and an extension of that signal that is repeated (e.g., an integer number of modulated SS like 4 repetitions to simplify description). In addition, each of these extended SS's may have one or more operations (from Recipe) performed on it, as described further below.

Note that in one embodiment, the same SS is used for the repetitions in the given SME (even if a potentially different operation is performed on each repeated SS inside the SME). In an embodiment to simplify, a limited set of operations inside a SME may be used. For example, in one implementation, these operations may include: time reversal (i.e., SS′(n)=SS(N-n), n=0, . . . N−1); conjugate operation (i.e., SS′(n)=SS*(n), n=0, . . . N−1); phase operations (e.g., extended generic case of +/−{1,j}, i.e., SS′(n)=exp(j·θ)·SS(n)); and/or frequency shifts (e.g., from a numerically controlled oscillator (NCO), i.e., SS′(n)=SS(n)·exp(j·2π·δ·n/N) with typically |δ|≤1 if the small/fractional frequency shift is mainly used to improve signal continuity at edges or spectrum use, or any larger δ if frequency shifts are also used to manage interference-mitigation); and/or a combination of any of these operations.

Note that SME extension is presented as a repetition of an integer number of SS to simplify description, but could also be slightly extended, similarly to OFDM Cyclic Prefixes, to better manage SME edges in real channels with echoes. As an example, instead of a cyclic extension of 3 times the SS, to have 4 cyclic repetitions of the SS, there can be 4.25 cyclic repetitions of the SS (to have a quarter symbol to smooth the signal and minimize inter-symbol interferences when there are echoes and filtering).

Note that in embodiments, SS inversion (minus) and π/2-rotation (j) are particular cases of the phase operator, and conjugation is generally a particular case of time-reversal (sequence played in the other direction, when sequences depict symmetries) with a potential frequency-shift.

An additional variation of the selected SS and/or Recipe of operations over several SMEs is possible to further extend Packet Interference Mitigation (PIM) in heavy network-loaded contexts (to increase simultaneous users without high performance drop). Encoding using adapted bit-level forward error correction (FEC) and interleaving may also be used to tolerate remaining spread errors and local interferences impact. As an example, a proper block FEC spreads information bits as much as possible on the considered block of the frame. Generic block encoding/decoding may be used (e.g., for packet headers), to adequately spread (interleave/encode/map) the information bits to symbols with a priori equal ‘information weight’ to be robust in the channel. In a particular embodiment, each information bit (after BIC encoding) is spread on several symbols, and several bit-levels (from MSB to LSB, as a symbol, among 2^{M}, can contain M bits) of these symbols, to leverage/mitigate potential biased SINR per information bit. In practice, precomputed block matrices G (size K×N) can be predefined for each potential K/N couple of headers. But a combination of smart interleaving/FEC encoding and symbol mapping to spread information bits is also possible.

The combination of SS repetitions and operations on these repetitions inside SMEs enables an increase in robustness to channel effects, noises, blockers, and especially interferences from the same kind of packets transmitted simultaneously on the same bands (e.g., of other users). At the same time, simple and efficient recombinations can be performed at a receiver having a priori knowledge of the transmitter modulation schemes and recipes. Embodiments may also present a good spread of energy over the dedicated bandwidth and SME duration.

Moreover, another optional feature considers progressive knowledge/refinement of a user group/ID along the packet (from signaling parts to final payload) allowing a receiver to efficiently receive expected packets or stop demodulation as soon as the frame is not going to succeed for the given user, improving power-savings.

Embodiments implementing Sweep Wide-Area Modulation (SWAM) can be seen as a modulation technique for an entire packet or one or more portions of a packet (e.g., a data portion). Depending on implementation, such precoded-OFDM modulations may be included as an extra mode or “modulation and coding scheme” (MCS) of a Wireless-Smart Ubiquitous Network (WiSUN-OFDM), or as a building block of a new and optimized system/standard, more flexible, and superset of a Large-Scale Low-Rate Network (like IEEE 802.15.4g WiSUN).

With embodiments, a single radio receiver can listen and demodulate several nodes at the same time, more easily and without losing too many packets or requiring too complex switching to handle nodes sharing a channel access.

As will be described herein, for long range wireless communications, several basic modulation options can be implemented. In general, a first such modulation scheme will be described and is referred to below as a “M1” modulation scheme. In this M1 scheme, a limited number of differential time-shifts of linear-sweeps can be used. More specifically, in this scheme degrees of freedom for modulation and PIM can be split as follows: a circular-timeshift is used for data modulation and is applied first; and thereafter other degrees of freedom (including but not limited to one or more of complex-conjugate, flip-sequence, phase-shift, frequency-shift) can be used for Groups/PIM.

A second such modulation scheme also will be described and is referred to below as a “M2” modulation scheme. In this M2 scheme, a differential sequence-correlation (conjugate substantially equal to orthogonal or further spread energy instead of coherently aggregating phased-energy) and frequency-offsets can be used. More specifically, in this scheme, degrees of freedom for modulation and PIM can be split as follows: complex-conjugate/flip and frequency-shift (among a subset of allowed coarse shifts) are used for data modulation, and are applied; and thereafter other degrees of freedom (including but not limited to one or more of extra complex-conjugate over repetitions, extra frequency-shift over repetitions, phase-shifts, circular-timeshift, small adjustment in slope of the sequence) can be used for Groups/PIM.

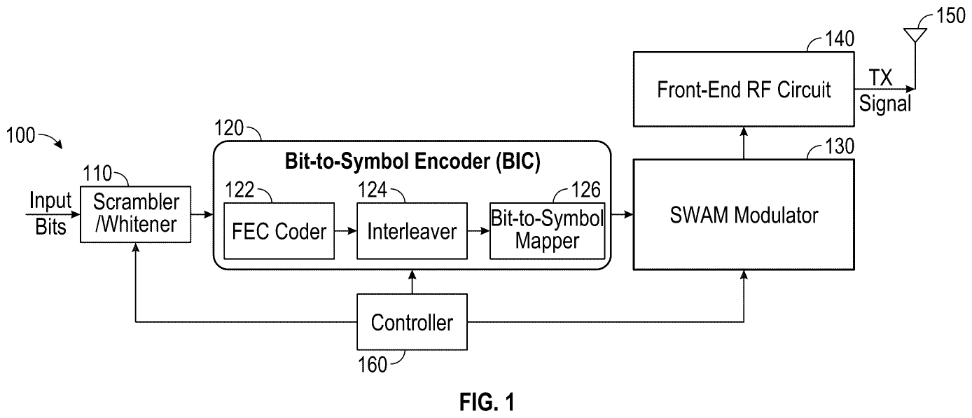

Referring now to FIG. 1, shown is a block diagram of a transmitter in accordance with an embodiment. More specifically, as shown in FIG. 1 transmitter 100 is configured to transmit packets according to a SWAM communication protocol in accordance with an embodiment. In the view of FIG. 1, all components (except for an antenna 150) may be implemented on one or more dies of an integrated circuit (IC). In some cases, all of the circuitry may be implemented on a single semiconductor die, while in other cases multiple dies may be present within an IC package. Transmitter 100 may be configured to leverage each information-bit (for reliability) at antenna 150 over a dedicated block, adapted to the selected modulation order and coding scheme.

As shown, incoming information in the form of an input bit stream (which may be generated within digital circuitry of the transmitter or a device coupled to the transmitter) are input into a scrambler 110. In various embodiments, scrambler 110 (which can be optional in some embodiments) may scramble and/or whiten the incoming bits, which are then provided to a bit-to-symbol encoder (generally encoder 120). In the high-level view of FIG. 1, encoder 120 is shown with constituent components, including an encoder 122, an interleaver 124, and a mapper 126. Encoder 122 is configured to perform FEC coding on the incoming bits. In turn the encoded bits are provided to an optional interleaver 124, which may interleave the incoming bits in accordance with a given interleaving scheme. The interleaved bits are then provided to mapper 126, which performs optional reordering and bit-to-symbol mapping to thus output a corresponding symbol from one or more of the incoming bits. Note a well-chosen block FEC could do all-in-one ‘smart bit-to-symbol’ encoding and mapping (especially for small blocks like headers), removing the need for extra interleavers and remappers/reordering.

Still with reference to FIG. 1, the symbols are provided to a SWAM modulator 130. As will be described herein, SWAM modulator 130 may perform a modulation of incoming symbols using a SS sequence. In addition, the modulated symbol may be extended, with the symbol repeated, e.g., copied one or more times. Then additional processing may be performed on each of these symbol copies, namely, a so-called Recipe of operations. Thereafter, optional signal shaping may be performed.

A resulting series of modulated and extended symbols (SMEs), optionally shaped/filtered/smoothed, is provided to a radio frequency (RF) front end circuit 140. Various digital and analog processing may be performed, including upconversion to RF level, filtering, gain control and amplification (including in a power amplifier of RF front end circuit 140), to result in a transmit RF signal that is transmitted via antenna 150. Note that the digital modulation of SMEs could be represented/generated as vectors of IQ samples (for IQ modulators) or as a vector of phase values (for direct phase modulation) with very high power efficiency to generate constant-envelope signals.

Still with reference to FIG. 1, a controller 160 is present. In various embodiments, controller 160 is configured to control the constituent components of transmitter 100. In particular embodiments, controller 160 may be a programmable hardware circuit that is configured to execute instructions such as may be stored in one or more non-transitory storage media.

In embodiments, controller 160 may, based on various parameters, control selection of the type of scrambling, encoding, interleaving, reordering and symbol mapping. In addition, controller 160 may, based at least in part on input parameters and/or symbol index, determine an appropriate SS to be used for modulation, and determine an appropriate Recipe of operations to be performed on the SS. Still further, controller 160 may be configured to control any optional signal shaping performed in SWAM modulator 130. Although shown at this high level in the embodiment of FIG. 1, many variations and alternatives are possible.

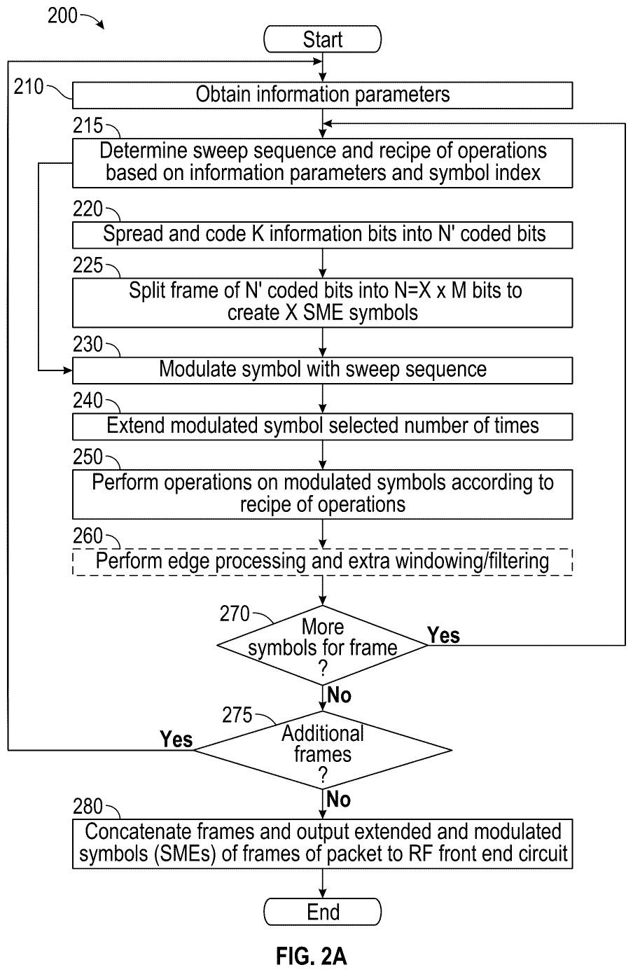

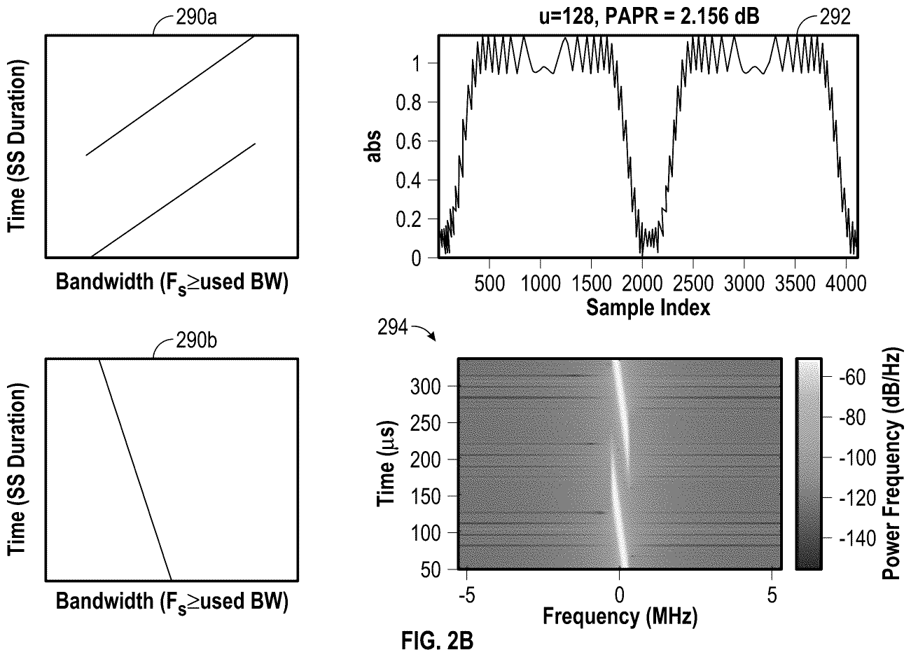

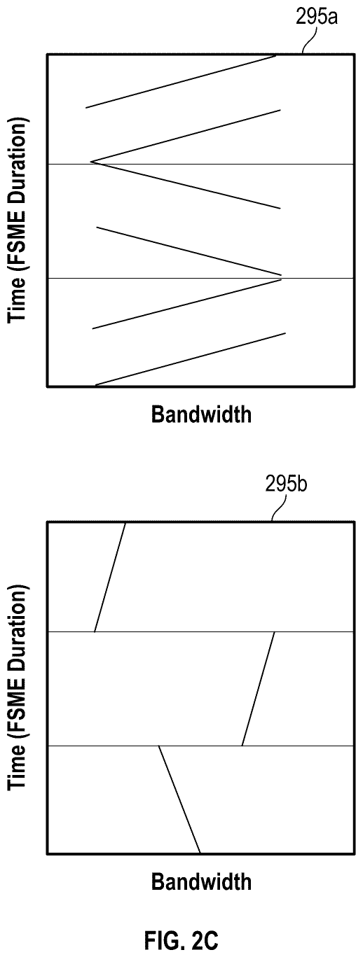

Referring now to FIG. 2A, shown is a flow diagram of a method in accordance with an embodiment. More specifically as shown in FIG. 2A, method 200 is a method for processing an incoming bit stream in a transmitter in accordance with an embodiment. As such, method 200 may be performed by hardware circuitry such as the transmitter shown in FIG. 1, alone and/or in combination with firmware and/or software. In such embodiments, the hardware circuitry is configured to execute instructions stored in one or more non-transitory storage media.

Method 200 demonstrates an overall flow for generation and communication of a packet from a transmitter to one or more receivers. In general, the flow of method 200 is illustrated for operations that can be performed iteratively for different portions (frames) of an overall packet.

As shown, method 200 begins by receiving information parameters (block 210). These information parameters may be received in a controller of the transmitter. Such information parameters may include certain fixed information parameters for a given type of modulation scheme. In addition, these information parameters may include information received from a network, and feedback information (or measurements) regarding (prior or current) communications from/to the transmitter.

Particularly relevant information parameters may include range information (regarding an estimated signal quality or distance between the transmitter and one or more receivers), group information, and “modulation and coding scheme” (MCS) information. Next, control passes to block 215, where the controller may determine a SS and a Recipe of operations based at least in part on at least some of the information parameters and a symbol index. As will be described, this determination is thus a dynamic determination that may be performed for each extended block of information to be communicated. The determination of blocks 210 and 215 may be performed by a controller of the transmitter.

As further shown in FIG. 2A, a set of incoming information bits (e.g., K bits) may be spread and coded into N′ coded bits (e.g., by performing FEC coding) (block 220). Thereafter this frame of N′ coded bits may be split into X·M bits (where M is a group of bits) to create X SME symbols (block 225). These operations may be performed in a bit-to-symbol encoder in accordance with an embodiment.

Still with reference to FIG. 2A, at block 230 a given symbol may be modulated with the selected SS within a SWAM modulator. Thereafter at block 240, this modulated symbol may be extended, e.g., using copies, a selected number of times. Although embodiments are not limited in this regard, in one implementation the determination of the number of times that a modulated symbol is extended or copied may be based on a cyclic prefix configuration parameter (CPₓ) that, in turn, is based on a given MCS. Thus, at this point there are a given number of identical modulated symbols present.

Still with reference to FIG. 2A, next at block 250 a set of operations may be performed on each of these modulated symbols according to the Recipe of operations, as determined above at block 215. Depending on information parameters, this set of operations may be the same or different for given ones of the modulated symbols. This resulting extended block of modulated symbols is referred to herein as an SME block.

Still referring to FIG. 2A, at optional block 260 (shown in dashed form), additional signal processing may be performed on the SME blocks. For example, various signal shaping such as edge processing and/or windowing/filtering may be performed to smooth edges, which may involve several SMEs (e.g., a current SME and a previous SME to filter edges). In implementations, the determination of whether to perform such operations as well as the type of operations also may be determined based upon one or more of the information parameters. Control next passes to diamond 270 to determine whether there are more symbols within the frame to be transmitted. If so, control passes back to block 215. If not, control passes to diamond 275 to determine whether there are additional frames within the packet. If so, control passes back to block 210 for obtaining further information parameters. Instead when a packet is completed, control passes to block 280 where multiple frames of the packet are concatenated and the extended and modulated symbols of the frames of the packet, optionally shaped/filtered/smoothed, are output to an analog RF front end circuit for upconversion and then transmission via a power amplifier and antenna. Although shown at this high level in the embodiment of FIG. 2A, many variations and alternatives are possible.

In one or more embodiments, SS's can be constructed with optional features to provide sequences having desirable properties that enable flexibility for different environments (e.g., ranges, simultaneous users, packet interference mitigation, and so forth). In an embodiment, a sequence may be generated using a GCS equation as described above. Additional operations optionally can be performed. For example, a portion of a sequence may be extracted/processed, such as performing a centering/shifting, removing one or more central values (DC=mean), ensuring symmetry, filtering edges, and/or adding zeros at edges. Understand that in different use cases, one or more of these optional operations may be performed to derive a sequence. In some implementations, this sequence may further be transformed into the frequency domain via a FFT operation. Further derivations can be performed on a transformed sequence using operations like Recipes (e.g., via a numerically controlled oscillator (NCO)) and potential windowing, to provide the final SS.

When a given SS list is selected for use in modulation, SMEs are constructed. For each symbol, a given SS is selected from the SS list using Group information and optionally symbol index. Then the SS is modulated with the symbol value (e.g., via a circular time shifting and/or a frequency shift (using an NCO)). The resulting modulated SS is extended to SME size (e.g., with CPx copies). Then based on PIM information and symbol index, a set of operations can be performed according to a Recipe of operations. Finally, potential edge processing and/or additional windowing/filtering may be performed (which may depend on SS and selected Recipe).

Referring now to FIG. 2B, shown are example SSs and graphical illustrations in accordance with an embodiment. In FIG. 2B, SSs 290a,b are two examples of a sweep sequence that have different slopes and bandwidth over time. As seen, the SSs can be filtered/zeroed at their edges such that their bandwidth is less than a sampling frequency. Graphical illustration 292 shows a transmitted SS having quite low PAPR, and illustration 294 shows an energy spread over time/frequency. While these figures provide only limited illustration regarding the waveforms in the complex domain (only displays absolute power here), they provide an example of possible solutions to manage continuity, shaping optimization, orthogonality, and spread of energy in time/frequency.

Referring now to FIG. 2C, shown are example SMEs in accordance with another embodiment. In FIG. 2C, SMEs 295a,b are two SME examples that have different SSs and Recipes over time.

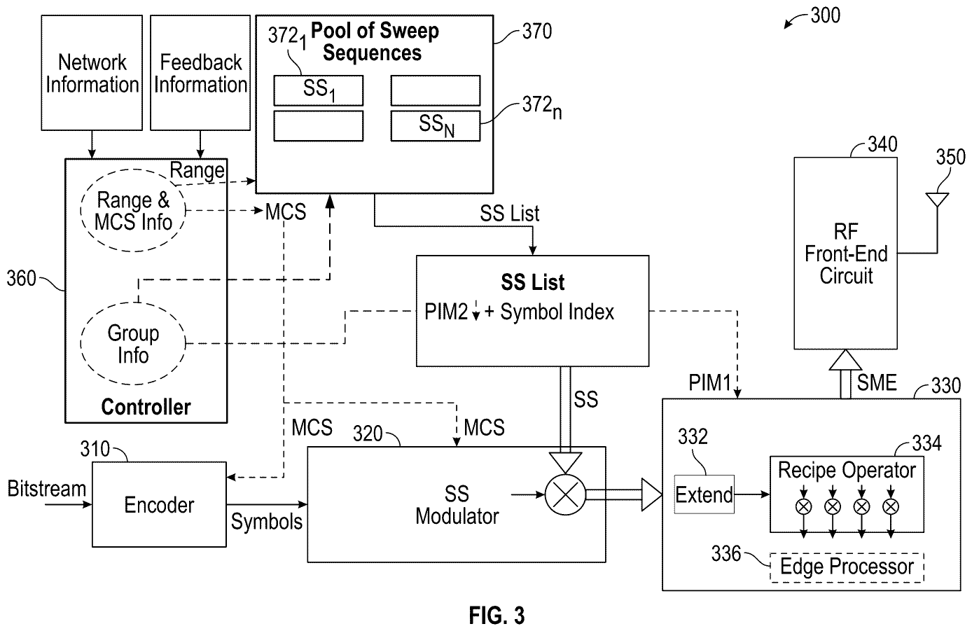

Referring now to FIG. 3, shown is a block diagram of a more detailed implementation of a transmitter in accordance with an embodiment. As illustrated, transmitter 300 includes various hardware, firmware, and software that forms a signal processing path to receive, code, modulate and transmit an incoming bit stream. In addition, a controller 360 is coupled to the signal processing path to determine selection of an appropriate SS, modulation scheme, replication, and Recipe of operations to be performed on the replicated modulated SS. To this end, controller 360 may be a programmable hardware circuit that is configured to execute instructions such as may be stored in one or more non-transitory storage media.

As shown, controller 360 can receive a variety of parameters, including information received from a network as well as feedback information and/or measurements. In an embodiment, the network information may include framing structures, tables of possible MCSs for a given Range, Groups and Recipe information and ways to select among a subset, and the feedback information may include channel characteristics (or measures) to select the Range and MCS and keys to define the Group information. In an embodiment, the Group information may be a value for a user in a cell area be as low as possible interfering with other signals, allowing selection of adequate SS and Recipes (avoiding similar waveforms in the same area).

In one or more embodiments, the main parameters for determining a modulation configuration are derived from Range, MCS and Group parameters. In an embodiment, the Range parameter defines the SS duration (size of building blocks), main packet structure and MCS pool definitions. The greater is the range, the better is the sensitivity and longer is the packet for the same content to transmit.

In different use cases, one or more of Range, PIM information and symbol index may be used in determining a SS sequence list to be used and what extension and Recipe of operations are to be performed. For example, controller 360 may determine configuration of modulation based on range only when there is a single or small number of users (e.g., less than a first user threshold) located at a close distance with respect to transmitter 300 (e.g., less than a first distance threshold). As distance (e.g., greater than the first distance threshold) and/or number of simultaneous users increases (e.g., greater than the first user threshold), range and PIM information may be used. And as further users and/or distance increases (e.g., greater than another distance and/or user threshold), range, PIM information and symbol index may be used to determine modulation configurations.

In light of the above discussion and depending on environment, there may be flexibility for at least three dimensions/types of information parameters to adjust the modulation to the environment/application: including Range, MCS (to select at least nb bits per symbol, i.e., nb modulation e.g., circular-shift possibilities per SS to handle channel echo impact, and FEC details and rate) and Group information. In this way, embodiments enable adaptation of Range, MCS, and Group for packet interference mitigation, to target a low error probability in any environment and condition.

Referring now to Table 1A, shown is an example of MCS pool definition in accordance with an embodiment of “M1” modulation, e.g., for long-range scenarios with SS sequences of size N_{f}/L=128*2. The number of repeated SS per SME is equivalent to x+1 in the CPx notation of this Table; e.g., “CP3” means a cyclic-prefix of 3 corresponding to 4 SS per SME. In this arrangement, here we consider TimeShift modulation with 2 to 64 shift states depending on the MCSy index. However, with more than 16 states (4 bits per FSS), performance can be degraded if channel impulse response is large (interfering echoes), generally limiting high MCS to high-throughput transmissions in favorable scenarios (low CIR) to keep receivers simple. Shown in Table 1A are 8 MCSs, which may be encoded using 3 additional MCS-signaling bits per given RANGE (here is a range with sequence length 128).

Following Table 1A, shown is Table 1B, which is an example definition for a particular MCS index (index 2) for such “M1” modulation.

TABLE 1A
Example of MCS pool definition for “M1” modulation
For Long-Range scenarios with SS sequences of size N_{f}*L = 128*2:

| Fs(Hz) = | LRSW FASWAM-TS MCS Proposal (base sequence duration = 192 μs) | | | | | | |
|---|---|---|---|---|---|---|---|
| 666666.67 | SOLUTION 2021 | | | | | | |
| MCS | Sequence | FASWAM | | FEC | RateVerif | | |
| index | *ovs | rate/ | CP | rate | ratio/ | datarate | |
| y(128) | (length) | Modulation | extension | (coding) | bps | (bps) | CIR_max |
| 0 | 128*2 | 1.0/TS2 | CP5 (1/6) | 0.5 | 0.083 | 434 | 96 |
| 1 | 128*2 | 2.0/TS4 | CP5 (1/6) | 0.5 | 0.167 | 868 | 48 |
| 2 | 128*2 | 3.0/TS8 | CP5 (1/6) | 0.5 | 0.250 | 1302 | 24 |
| 3 | 128*2 | 3.0/TS8 | CP3 (1/4) | 0.5 | 0.375 | 1953 | 24 |
| 4 | 128*2 | 3.0/TS8 | CP3 (1/4) | 0.667 | 0.500 | 2604 | 24 |
| 5 | 128*2 | 4.0/TS16 | CP3 (1/4) | 0.667 | 0.667 | 3472 | 12 |
| 6 | 128*2 | 5.0/TS32 | CP3 (1/4) | 0.667 | 0.833 | 4340 | 6 |
| 7 | 128*2 | 6.0/TS64 | CP3 (1/4) | 0.667 | 1.000 | 5208 | 3 |

TABLE 1B
for ″M1″ Modulation

EXAMPLE DEF for MCSp2: % MCSp2 for PHR2
rat_str = ‘FASWAM 3.0’;
mtz_str = ‘TS8’; % TimeShift 8-states
sym_str = ‘2*128’; % FASWAM SS/size
syr_str = ‘CP3’; % GI copies: length3
cod_str = ‘BCH(32, 16)’; % FEC BCH-based

TABLE 2
Example of MCS pool definition for “M2” modulation

| | | | | | Rep L | |
|---|---|---|---|---|---|---|
| | FSME- | | NbitFreqS | | FSS per | |
| MCS | rate | NbitSlope | Bit | FEC-rate | FSME | Global |
| index | Bit/FSME | bit slope | freqshift | Rc | 1/Rr | Rate |
| 0 | 1 | 1 | 0 | 0.333 | 6 | 0.056 |
| 1 | 1 | 1 | 0 | 0.333 | 4 | 0.083 |
| 2 | 1 | 1 | 0 | 0.500 | 6 | 0.083 |
| 3 | 1 | 1 | 0 | 0.500 | 4 | 0.125 |
| 4 | 2 | 1 | 1 | 0.333 | 6 | 0.111 |
| 5 | 2 | 1 | 1 | 0.333 | 4 | 0.167 |
| 6 | 2 | 1 | 1 | 0.500 | 6 | 0.167 |
| 7 | 2 | 1 | 1 | 0.500 | 4 | 0.250 |
| 8 | 4 | 1 | 3 | 0.333 | 6 | 0.222 |
| 9 | 4 | 1 | 3 | 0.333 | 4 | 0.333 |
| 10 | 4 | 1 | 3 | 0.500 | 6 | 0.333 |
| 11 | 4 | 1 | 3 | 0.500 | 4 | 0.500 |
| 12 | 4 | 1 | 3 | 0.667 | 6 | 0.444 |
| 13 | 4 | 1 | 3 | 0.667 | 4 | 0.667 |

Where Repetition L is (CP extension + 1)

Still with reference to FIG. 3, based at least on the MCS information, controller 360 configures an encoder 310 that receives an incoming bit stream, to perform adaptive coding and interleaving to transform incoming bits into symbols (e.g., K bits into X corresponding symbols).

The resulting symbols (e.g., X symbols) are provided from encoder 310 to a modulator 320. Controller 360, based at least on the MCS information, configures modulator 320 to perform a modulation of the incoming symbols using a given SS, namely a selected SS from the list of SS's (for the packet group) from a plurality of lists of SS's that are stored in a pool of sequences. In an embodiment, modulator 320 uses a selected SS (selected by controller 360 as described below) to modulate (a single) symbol. In an embodiment, this modulation is a circular shift of the selected SS. In another embodiment, it is a conjugate and/or circular frequency-shift of the selected SS.

As shown in FIG. 3, this pool of sequences may be stored in a memory 370. The pool of sequences may include a plurality of separate sequence lists 372₁₋ₙ. These sequence lists may depend upon various parameters. Each sequence list may have a number of sequences, where each sequence can be defined from a vector of complex numbers, either in time or in frequency domain (before OFDM FFT). For constant-envelope SS, each sequence can also be defined as a vector of phase values (simpler).

In embodiments, the pool of sequences includes sets of SS that are predefined and/or computed, and which have good properties, in particular good auto-correlation and inter-correlation properties. In this way a SS and its circular-shift can be identified, having localized/peaky circular auto-correlation, and low circular inter-correlation with any shift of other SSs of sequence lists 372.

Variations in sequence lists 372 may be used to enable flexibility in packet communications to accommodate different numbers of simultaneous users. For example, different sequence lists having a same number of values (but differing values) can be used to provide concurrent or simultaneous transmissions to multiple users in an environment. And longer SS may be used for communications with more distant users within a wireless environment.

Depending upon implementation, the pool of sequences may be stored in a non-volatile memory where the pool is predetermined and stored as part of firmware. In other cases, the SS may be dynamically determined and stored, e.g., in a lookup table, or even generated ‘on-the-fly’ or dynamically, using the GCS/ZC equations described above.

In an embodiment, oversampled versions of predefined SS sequences can be saved in memory 370 to further optimize and pre-shape the signal. In some embodiments, a typical twice-rate definition (either in time or frequency) could be used as a basis for next modulation steps. Note that SSs can be selected to generate signals close to constant-amplitude modulations, and it is even possible to compress the final signal amplitude without modifying modem generic algorithms and without significantly reducing performance. In other embodiments, a subset of SS sequences can be stored in memory 370 (to reduce memory consumption) and then controller 360 can use these stored subsets to generate a complete sequence. For example, memory 370 may store a portion of a given sequence, and one or more processes may be applied to this stored sequence (e.g., symmetry: half-size and reverse to obtain a whole sequence). In addition, possible operations (e.g., conjugate), and/or filtering/resampling/FFT-OFDM may be performed to obtain a final SS used for a given SME.

In an embodiment, the SS selection may be based at least in part on a sequence size, which can be determined from range information, and may further be based on PIM2 parameters from the group information. In an embodiment, the range information may be used to obtain a list of SS (with defined size N_{fft}), and the PIM information (from group information) along with a symbol index may be used to select the SS from this list of SS.

Still with reference to FIG. 3, modulator 320 modulates a given symbol index with this SS, where selection of the modulation scheme can also be based on the MCS information.

Depending on implementation, the resulting SMEs can transmit information based on SSs using: shifts (time or frequency cyclic shifts of SSs); complex-multiplication (IQ) on the SS signal (including potential inversion, phase modulation, amplitude modulation); and different SSs over time. In some embodiments, shifts are considered for modulation only, to allow other dimensions to be used for PIM.

To simplify processing, choices can be made at early design stages. As an example, for one implementation a Sweep Scalable Simultaneous-access Wide-Area Network subset system is defined with a given modulation scheme that is based (only) on circular shifts of the SS. Amplitude modulation is not used (to keep PAPR low). Other degrees of freedom are not used to modulate information but to increase robustness through PIM techniques described below. In other words, potential further operations on the SS (including IQ processing like signal inversion, phase shift and drift, and SS variation or conjugation) can be used in combination with repetitions to leverage interferences and noises (instead of for modulating data information), allowing simple but efficient and future-proof receivers.

In turn, the group parameter extends the signature to manage PIM (defines scrambling and PIM indexes). In one embodiment, the group information may be mainly derived from previous exchanges (network association, previous packets) and/or previous portions of a packet (header containing fields that define the group selected for the next packet portion) provided within some part of a packet, and may be divided in two subsets, PIM1 and PIM2. The PIM1 parameter can be used to define an intra-SME Recipe (vector of operations for the given MCS depends on this PIM1 index). In turn, the PIM2 parameter can be used to define an inter-SME potential variation of the selected SS and/or Recipe (e.g., select the SS over the frame, such as a constant SS index or a repeated vector of SS indexes among the SS list to further scramble interferences).

The resulting modulated symbol is extended a selected number of times in an extender 332, and is provided to a Recipe operator 334 that applies a Recipe of operations on each copy of the modulated symbol. In embodiments, extender 332 may copy the modulated symbol a given number of times (e.g., based on MCS CPx, with recipe length of usually equivalent length, defined at least in part on PIM1 information). In various embodiments, Recipe operator 334 may be configured as a programmable processor, which can be implemented within or apart from modulator 320. Additional processing such as windowing, filtering or so forth may be performed in an optional edge processor 336. While in FIG. 3 separate extender, Recipe operator and edge processor are shown, in other cases a given modulator may include processing circuitry to perform all of these operations.

In embodiments, controller 360 determines this Recipe of operations based at least in part on the PIM1 information, which may be based at least in part on the group information of the information parameters. The resulting extended and modulated symbols may further be signal shaped within Recipe operator 330 (where this determination may be based on additional PIM1 information).

Referring now to Table 3, shown is an example of operations performed on a SS (for SME construction).

TABLE 3

| | |
|---|---|
| % * 0: nothing, | s(n)=cpx( I(n), Q(n)) |
| % * 1: inverse, | −s(n)=cpx(−I(n),−Q(n)) (negate values) |
| % * 2: rotatIQ, | js(n)=cpx(−Q(n), I(n)) |
| % * 3: rotIQinv, | −js(n)=cpx( Q(n),−I(n)) |

% Add 4 to conjugate: s*(n)=cpx( I(n),−Q(n))
% Add 8 to time-reverse: SS(n)<=SS(N−n), n=0,...N−1
% Add 16*D to apply NCO:
SS(n)<=SS(n)*exp(j.π.δ.n/N)
with δ in [-N/2:0.5:N/2]

Note that phase continuity over all the packet is often preferred; time reversal and/or conjugation operations with well-chosen recipes can ensure such phase continuity, to decrease unwanted emissions (out-of-band spectrum regrowth) when filtering in the front-end. Although a reduced number of operations are presented in this example, other sets of operations are possible in other embodiments, in particular extending the allowed values of delta for frequency shifts. Note that phase continuity over all the packet is often preferred; time reversal and/or conjugation operations with well-chosen recipes can ensure such phase continuity.

Referring now to Table 4, shown is an example of Recipe definitions for an example SME construction for an “M1” modulation. As an example, for the 5 rows shown (which may be selected based on a PIM1 index), when the current MCS assumes 4 SS per SME (‘CP3’ like MCS{3-7} in Table 1), the values in Table 4 correspond to the listed operations to be performed on the SSs according to a given Recipe of operations.

TABLE 4
for ″M1″ Modulation

```
% if CP_nbSS == 4 % SME from 4 SS: Example of operation vector
  TAB_GID2_PIM1 = [
  0, 0, 0, 0; % [s s s s]
  0, 0, 1, 1; % [s s −s −s] % Negative for the 2 last SSs of each SME
  0, 1, 0, 1; % [s −s s −s] % Negate 1 SS over 2
  0, 3, 1, 2; % [s, −js, −s, js]
  0, 4, 1, 5; % [s, s*, −s, −s*]
  ... ]
```

TABLE 5
for ″M2″ Modulation

Recipes can be defined as vectors of Slope signs and
FreqOffset values:

| | |
|---|---|
| ○ | Example of Recipe over 2 FSME = 8 FSS here |

(assuming L=4 FSS per FSME), using 2 operators
{RevSlope, FreqOffset}:

| | |
|---|---|
| RevSlope Sr = [1, 0, 1, 0, 0, 1, 0, 1] | (1 means a |

negative slope ~conjugate*)
FreqOffset Qr = [-16, -16, -8, -8, 24, 24, 8, 8] (~lower
subcarrier position of the FSS after Recipe)

| | |
|---|---|
| ○ | (This is like a supercode combination only shared |

through Range*Group and allowing a specific signature to
discriminate signals (robustness), further improving packet-
interference mitigation.

Note that the processing and operations can be performed in the module/phase domains instead of I/Q quadrature domains (usual representation of complex values) through polar conversion; for constant amplitude targets, this could be implemented with phase modulators instead of IQ modulators. This process can simplify the phase continuity at edges.

As in OFDM, a circular time-shift of a SS is equivalent to a linear-varying phase shift in the frequency domain (with the DFT conversion of OFDM), which is, in the case of linear-frequency-sweeping SS, similar to a circular frequency-shift. A transmitter as well as a receiver may leverage this property to simplify demodulation and perform algorithms either in time or frequency.

With embodiments, robustness in real environments is improved, not only using the presented schemes (SS, PIM), but also considering sufficient minimal shifts between symbol depending on the Channel Impulse Response (CIR) (equaling echo spread), as presented in MCS tables.

Robustness and compromises in real channels (multipath and multi-user) can be increased using: cyclic-prefix-like extension of the signal (e.g., full repetitions of the signal, or at least large compared to conventional OFDM, which often considers only a small fraction of the symbol as a cyclic extension) to simultaneously handle channel spread/echoes and potential spreading groups coding over repetitions; variations of the selected SS, among the SS list, over time; and encoding and spreading at several levels. Such operations may avoid interference with similar packets, transmitted simultaneously in a real multi-user system.

A SWAM-modulated block is thus a succession of SME symbols where a SME is constructed from: a selected SS (with a given duration and sequence content); a modulation (i.e., symbol information to transmit; 1≤N≤log₂(N_{fft}) bits per SME in M1); and a Recipe, i.e., the operator scheme over the SS repetitions (e.g., a vector of operations).

Embodiments may dynamically determine generation of a SWAM block to balance throughput and robustness (both in terms of range/SNR/echoes and interference capabilities). As discussed above, all of Range, MCS, PIM information and symbol index may be used. In this way, communications may target very low sensitivity, and leverage robustness, while still being efficient as it is flexible and scalable when the context permits smaller packets at higher throughputs. In one or more embodiments, SME and payload block construction process may be performed independently for each part of a frame communication (e.g., one or more headers and a data payload).

Still with reference to FIG. 3, the resulting SME is provided to an RF front end circuit 340 for various processing to result in an RF signal to be transmitted via an antenna 350. Although shown at this high level in the embodiment of FIG. 3, many variations and alternatives are possible.

Note that transmitter 300 may transmit a packet as a collection of frames, where there may be different frames for preamble, training field, header1, header2, and data (as an example). Each frame may have its own settings (defined from fixed/top-level common parameters and/or a previous frame). In turn a frame may be constructed with a given number of SMEs. Headers generally have a fixed and known number of SMEs for a given MCS. A data portion of a packet may be formed of a variable number of SMEs (each packet having different number of bits to transmit, where a data length is given in the headers).

In addition to the flexibility afforded by the above parameters, controller 360 also may enable greater reliability in difficult environments using sub-block interleaving. Thus in some implementations, an optional sample-subblock-level interleaving may be performed. Such interleaving may be performed to increase robustness in difficult channels with potential varying-over-time noises and interferences (e.g., localized/peaky or impulsive noises). This interleaving is performed on the samples of each SME over the packet, as it is often too late at bit-level to deinterleave information that is already poisoned by localized high-level noises that give high but wrong reliabilities to a given symbol at the receiver.

Thus to provide additional robustness, optional sample-subblock-level interleaving may be performed to spread ‘sample-level information’ over a packet by splitting each SME into P subblocks. In one or more embodiments, this optional feature can be activated on a per packet basis (e.g., via a bit field option in a header of each packet) or fixed by the network or from a design choice for a given application.

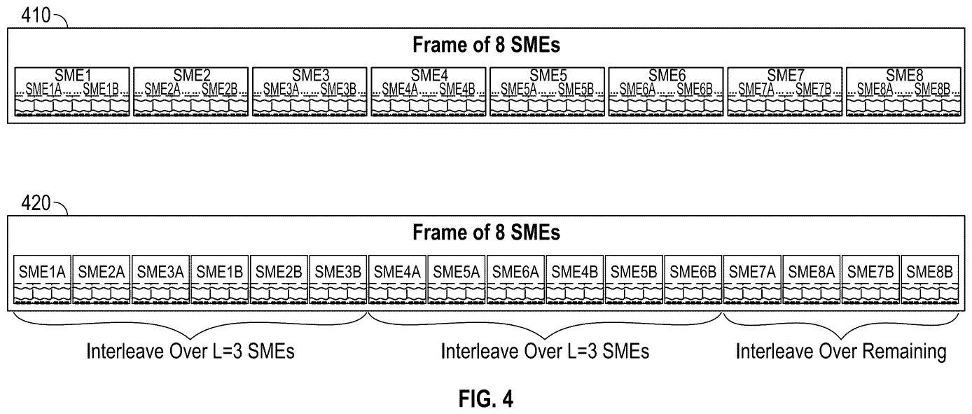

Referring now to FIG. 4, shown is a block diagram illustrating representative frames in accordance with an embodiment. First, a frame 410 is illustrated without interleaving. In this example, frame 410 is shown having SME symbols (each symbol with a MCS CP5, i.e., 6 SS ‘copies’ per SME) and a sub-block length of SME length/2 (P=2). As shown, without interleaving frame 410 is generated and transmitted with each SME symbol contiguous (the split into two sub-blocks each of 3 SS is not requested). In turn, frame 420 is illustrated with interleaving activated.

In the example shown, frame 420 has a configuration with a simple spread over 3 SMEs to generate and send information with a simple interleaving of SME1A, SME2A, SME3A, SME1B, SME2B, SME3B, SME4A, SME5A, SME6A, SME4B, SME5B, SME6B, SME7A, SME8A, SME7B, SME8B. As seen, the first operation is to group per block of L SME (where L=3 here), with the last block for a given frame length being of size between 1 and 3. And the second operation is a simple reshaping/reordering per P sub-blocks, where P=2 here, that splits each SME into P parts equally interleaved within the frame.

The optional features to split into sub-blocks in time or in frequency (e.g. interleave in time SMEs as presented on FIG. 4; and interleave in frequency and consider recipes with high-values of frequency-shifts and low-values of U sweeping slopes in SS) can allow to further improve performance with more advanced receivers in specific environments that have more localized noises and interferences.

In general, demodulation of received packets may proceed in a reverse fashion to transmission, based on information parameters as discussed above (including Range/MCS and Group). Depending on implementation, this information may be fixed (e.g., standard/network/negotiated), or based on information obtained in a previous part/frame of a packet (e.g., to refine MCS and group information progressively). Once an initial packet detection and synchronization process is performed, the information parameters may be used to perform demodulation of each SME as follows.

First, the SS and Recipe of operations as used on the transmitter side to modulate symbols may be determined based on the information parameters and symbol index. Note that there can be a potential combination of several subparts of SME. In general, the operations performed on the transmit side may be performed in reverse order, i.e., potential edge processing (e.g., windowing/removal/weighting) may be performed, then a reverse Recipe of operations is performed, and finally the resulting SSs of the SME are aggregated to form only one received “denoised” SS.

Once the SS is recovered, it is processed either in frequency (after a FFT operation) or in time. Then a correlation is performed with an expected SS to find a most probable modulation. In a frequency domain, the cyclic correlation of sequences is equivalent to a dot product of their Fourier transform (after complex conjugation or time-reversal of one sequence). In this operation, a symbol shift can be easily derived from analysis of an inverse FFT (IFFT) operation on this correlation.

To understand, in an example without cyclic-shift (modulation0), the correlation of a sequence with itself (conjugate) results in a flat sequence in phase/angle (and even is a sequence of 1 if the SS has complex values of module 1 like CAZAC sequences), related to an IFFT with a peak in index 0 (frequency shift=0). For Sweep-Sequences, the higher the modulation shift is at a transmitter, the more cycles of sinusoids are present in a correlation vector, resulting in a related FFT with a peak at an increased index that gives an initial modulation cyclic shift. This cyclic shift is used to find/estimate the most probable transmitted cyclic shift among the 2^{M} symbols, or to derive soft values of probabilities (reliabilities) for each potential 2^{M} symbols in a very noisy reception environment.

This process may proceed in a loop as long as there are more symbols to process. Then, the most probable transmitted bits are deduced from a soft processing (similar to soft-FEC decoding) on the previous soft values per symbol, as a reverse operation of the transmit BIC operation to provide the transmitted bitstream.

In other embodiments, a different receiver may be used to improve performance. As an example, knowing/estimating CIR, especially in case of channel echoes, principles similar to a rake receiver can be used to better recombine echoes with adequately corrected correlations on several main paths. Note that receiver algorithm simplifications may occur in case of linear-frequency-sweep sequences.

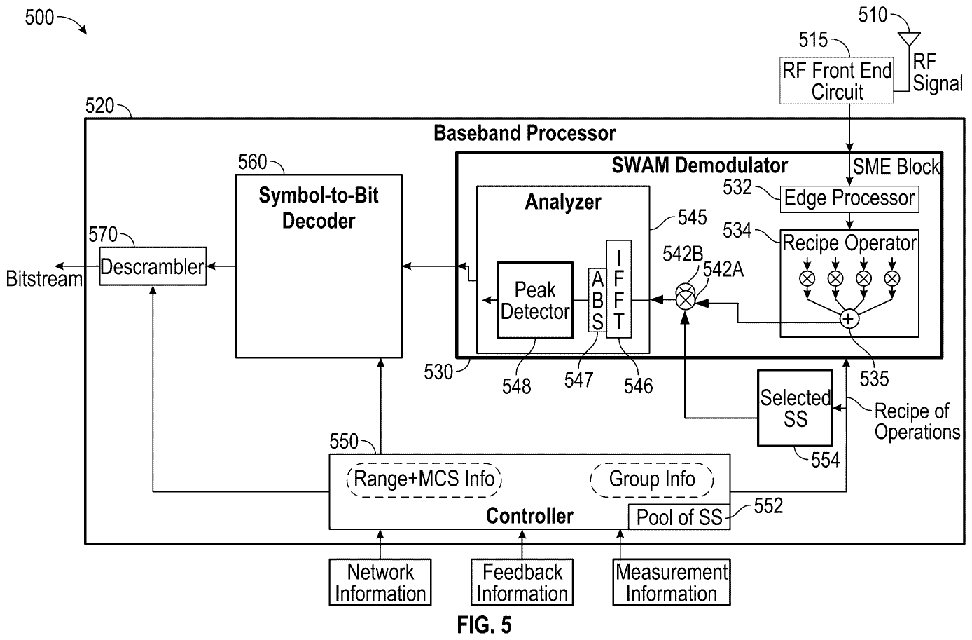

Referring now to FIG. 5, shown is a block diagram of a receiver in accordance with an embodiment. As shown in FIG. 5, receiver 500 is configured to receive and demodulate information using a SWAM demodulator as described above. Although shown as a separate circuit, in some cases, a transmitter and receiver can be implemented as a transceiver in a single device (and may share at least some common circuitry).

As shown, incoming RF signals are received via an antenna 510 and provided to an RF front end circuit 515. Front end circuit 515 may perform various RF processing, including amplification in a low noise amplifier, filtering, downconversion and digitization. In turn, resulting digital information, e.g., at baseband, is provided to a baseband processor 520.

Baseband processor 520 may perform various preparatory processing before providing resulting SME's to a SWAM demodulator 530. As shown, demodulator 530 is configured to perform a reverse set of operations as performed in a modulator on the transmit side. The selection of operations and configuration of demodulator 530 may be performed under control of a controller 550, which may determine an appropriate configuration of demodulator 530 to perform demodulation based at least in part on the information parameters, including Range, MCS information and Group information, as discussed above. Depending on implementation, this information may be received as one or more of network information, feedback information, and/or measurement information. Based on at least some of the information parameters, controller 550 may determine an appropriate reverse Recipe of operations to perform on incoming SME block to enable recovery of a given symbol as well as to determine whether shaping operations including edge processing, window and filtering or so forth is to occur. Controller 550 may be a programmable hardware circuit that is configured to execute instructions such as may be stored in one or more non-transitory storage media.

As shown, SME blocks are provided to an optional edge processor 532 to perform any edge processing, windowing or filtering as indicated under control of controller 550. Thereafter the SME blocks are provided to a Recipe operator 534, which may perform a reverse Recipe of operations on the SME block, as instructed by controller 550 to recover original SSs.

Thereafter, via combiner 535 the separate SSs are aggregated into a single denoised SS, or processed separately in a loop overs SSs.

In turn, this SS could be provided to a FFT engine 540 for transformation to the frequency domain. Understand while shown in FIG. 5 as being processed in the frequency domain, in other cases the recovered SS may be processed in the time domain. And the frequency domain SS (in the form of a plurality of subcarriers) is provided to dual correlators 542A, 542B for execution of a correlation as a dot product operation between an incoming SS and the selected SS 554 and its conjugate. Note that controller 550 may select selected SS 554 from a pool of SS 552 based on the information parameters (e.g., Range, Group).

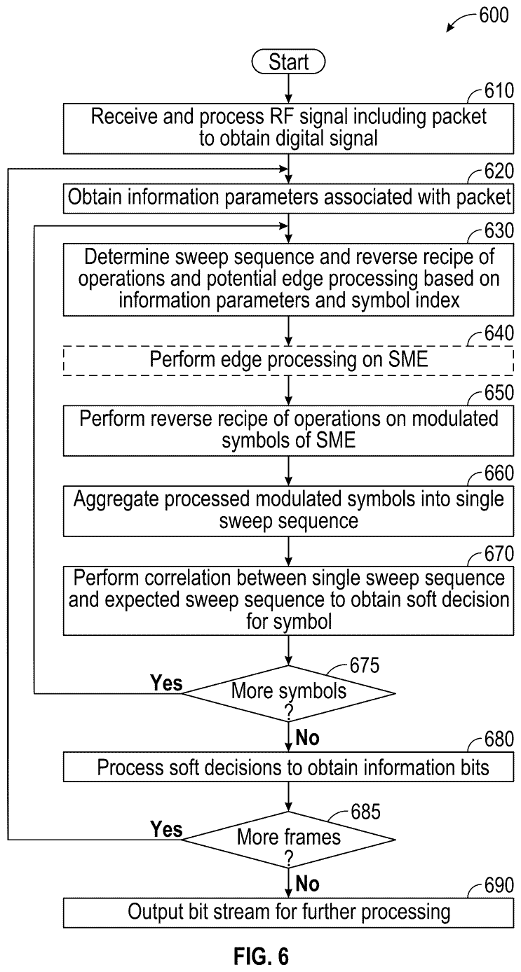

Still with reference to FIG. 5, correlation results (or dual correlation if performed both with expected SS and its conjugate SS*) are provided to an analyzer 545. As shown, analyzer 545 can include an IFFT engine 546 to identify the number of cycles in the correlation vectors corresponding to a modulation/shift. Thereafter, in one simple embodiment, an absolute value of the correlation results may be obtained in an absolute value operator 547. Thereafter, the values are processed in a peak detector 548 (or smarter processing) to identify a maximal correlation value to identify a given symbol. In the FIG. 5 implementation, analyzer 545 is a very simple hard decision analyzer (as shown), however a soft decision analyzer may be used in other implementations (such as described in the context of FIG. 6). Also note that while FIG. 5 shows an implementation with a dot product and max operation, in other embodiments progressive capabilities may be provided for advanced algorithms for more advanced/powerful receivers.

In turn, this symbol is provided to a symbol-to-bit decoder 560 to output information bits that are then provided to an optional descrambler 570. Descrambler 570 may descramble the information bits to result in a bitstream that can be provided for further processing within baseband processor 520 or another location within a receiver. Understand while shown at this high level of FIG. 5, many variations and alternatives are possible.

Referring now to FIG. 6, shown is a flow diagram of a method in accordance with another embodiment. As shown in FIG. 6, method 600 begins by receiving and processing an RF signal that includes a packet (block 610). This processing includes amplification in a low noise amplifier, filtering, (optional) additional gain control and so forth, down conversion to a lower frequency signal, and digitization to obtain a digitized signal. Next at block 620, various information parameters associated with the packet may be obtained. These information parameters may include range, MCS and group information as discussed above.

Still with reference to FIG. 6, at block 625 a SS and a reverse Recipe of operations may be determined based on the information parameters and symbol index. At least some of this information (and also measurements) also may be used to determine whether additional processing, e.g., edge processing is to be performed. At this point, the digitized signal may be processed, beginning with optional edge processing in optional block 630.

Next at block 650 the determined reverse Recipe of operations may be performed on modulated symbols of the SME.

An aggregation process then can be performed at block 660 to aggregate the processed modulated symbols to result in a single SS. Note that the processed modulated symbols may present different levels of reliability (or equivalent SINR), especially if interleaving options are activated (sub-blocks spread in time and/or frequency); then, advanced receivers could detect/measure this to weight the processed modulated symbols before aggregating them to a single SS. This aggregation may be a smart weighted aggregation to avoid integrating noise or high interference on the symbols. Thereafter at block 670 a correlation may be performed between the single SS and a selected SS. In embodiments, more specifically a double correlation may be performed with 2 expected sweep sequences (S and its pair “reversed slope’) to obtain a soft decision. In this way, soft estimations for the symbol are obtained, also termed “symbol-likelihood-values,” as in some cases a soft decision analysis may be more optimal to provide more/accurate soft information to a symbol-to-bit decoder (such as decoder 560 of FIG. 5).

Another option at blocks 660 and 670 is to process each SS in a loop; to perform correlations between the received sequence and expected SS and its conjugate SS* and then gather and analyze the correlations (or its FFT) to obtain the related soft information.

As used herein, note that these processed decisions may be referred to generically as “symbols,” whether they are hard decisions or soft estimations (symbol-likelihood-values”), since depending on implementation hard decisions or likelihood values can be output.

Then it may be determined at diamond 675 whether more symbols are present. If so, control passes back to block 630, discussed above. In other implementations, note that the operation of 660 and 670 may be reversed. After multiple symbols have been obtained, control passes to block 680 where these soft estimations may be processed to obtain a set of information bits. In this process, given the spreading of information over multiple SMEs, several soft decisions from several symbols may be processed to properly deinterleave (if needed) and decode (in an FEC decoder) them to obtain the final information bits. Thus in the embodiment of FIG. 6, several reliability/soft-decision values are provided, comparing each received symbol with all potential (2^{M}) symbols, to have all the information and be able to take the best decision in the decoder. These information bits may be output as a digital bitstream for further processing (block 690). Although shown at this high level in the embodiment of FIG. 6, many variations and alternatives are possible. For example, in another implementation, correlations may be performed both with the expected sequence and its pair (‘reversed slope’) before smart aggregation of the related soft-information to deliver a soft-decision on a symbol.

In one embodiment, the correlator and analyzer processing may be done in time from the received and expected sequences. One or several correlations or part of correlations (per block), with one or several circular shift and filtering of one of the sequences (received or expected, one of them being generally conjugated before the operation), provide enough information to the analyzer to perform the symbol detection or the delivery of (generally 2^{M}) symbol-likelihood-values for each received SME. These symbol-likelihood-values can be seen as real values measuring the probability that the received symbol is equivalent to each of the 2^{M} potential symbols; the higher is the better. The soft-decoding (reverse FEC) can advantageously benefit from this information to provide the most probable bitstream.

In another embodiment, the correlator processing may be done in frequency from the received and expected sequences. One or several correlations, dot product or part of it, with one or several circular shift and/or filtering of one of the sequences (received or expected, Fourier-transformed, one of them being generally conjugated before the operation), provide enough information to the analyzer to perform the symbol detection or the delivery of (generally 2^{M}) symbol-likelihood-values for each received SME.

In another embodiment, the correlator processing may be done in frequency and in time from the received and expected sequences. One or several correlations, dot product or part of it, with one or several circular shift and/or filtering of one of the sequences (received or expected, Fourier-transformed, one of them being generally conjugated before the operation), can be done to estimate the most probable modulation shifts. Then, another processing, in frequency or in time, from the same received and expected sequences with additional processing (circular shifts, filtering), can refine the estimation of correlation probabilities around the expected shifts (up to 2^{M} potential symbols) to provide enough information to the analyzer to perform the symbol detection or the delivery of (generally 2^{M}) symbol-likelihood-values for each received SME. This extra processing can also be used to track the TX-to-RX drift, i.e., synchronization derives, to correct the receiver algorithms and/or potentially adjust its clocks.

In one embodiment, as a simple and robust solution, the analyzer can search for most probable shifts or symbol-likelihood-values using the absolute values of the FFT of correlation(s) (without considering the phase). This is a robust solution to provide values without needing accurate synchronization nor tracking.

In another embodiment, as an algorithm improvement, the analyzer can consider the complex-valued FFT/correlation(s), and potentially previous phase estimation, to decrease its equivalent noise in correlation (projection on a given phase of the noise can divide by a factor 2 the equivalent noise after correlation).

In another embodiment, as another algorithm improvement, the analyzer can consider several times the previous processing, like a Rake-receiver, after the estimation of several relevant paths (CIR) in a channel with strong echoes. Such a multipath environment detected in previous synchronization steps or from the tracking process, can trigger this extra processing to still improve performance in these most difficult channels.

Note that in case of linear-sweep SS, optimizations for efficient demodulation can be done replacing intensive Rake processing by simpler filtering, as the CIR appears in correlations steps; allowing several designs of low-power low-cost receivers with good performance.

To improve performance while keeping a rather low processing complexity, the Maximum-Ratio-Combining principle can then be applied on the recombination/aggregation of subblocks of SMEs. Over the whole duration and bandwidth of the SME, if SME is split in P subblocks in time and N subblocks in frequency (considering N=CPx+1 repetitions of narrow sweeps and recipes with NCO moving the SS over frequency blocks), receiver algorithms can advantageously weight these subblocks before their aggregation, to mitigate the effects of localized interferences on the single denoised SS.

To further improve performance, the Maximum-Ratio-Combining principle can then be extended on main channel paths (CIR), that will appear after an FFT on correlations, to get very good performance while simply aggregating energy on expected bins.

In one embodiment, to further improve performance (including increase coverage while preserving the wireless resource limiting retransmissions, also allowing measurements among the gateways to select the best one(s) for each user), in a network where several Gateways receive the transmitted packet in uplink transmissions, the symbol-likelihood-values for each received SME of a given packet can be generated at each Gateway. These values are then sent to a centralized server that will optimally gather and decode this soft-information to provide the final bitstream.

In other implementations, an alternative to the above-described modulation technique (referred below as ‘M1’) may be used to differently share the degrees of freedom of the waveform between the modulation of the information bits to transmit and the processing to improve robustness (including diversity and PIM). As discussed above, certain implementations may modulate input symbols by circular-timeshifts of a given sweep-sequence (SS), and then improve robustness by extending the sequence (via repetitions) and applying recipes on the sequence (e.g., with a different operation (each of which may be a combination of one or more basic operations) on each repetition). In various implementations, these recipes may include a combination of one or more of complex conjugate or flip of the sequence (or its complex conjugate), frequency shifts, null operations, and/or phase shifts.

In another implementation, information modulation may be realized by modulating input symbols by selecting a given starting frequency-offset and a given direction of a given SS, and then using other degrees of freedom (such as one or more of those described above) to improve the robustness (where these other degrees of freedom include sweep sequence and slope, and repetitions with given recipes). This alternate modulation scheme is referred to herein as an ‘M2’ modulation. Such information modulation may be well-suited to the waveform continuity used in very-low-power applications, while providing extra capabilities to handle realistic long-range channels with many interfering signals and with simple transceivers.

For this implementation consider a similar basic block element (SS) as the sweep sequences of a M1 modulation. Ideally, the modulation may be performed with an ending phase in line with a starting phase of a next block, or a direct phase modulation technique to ensure phase continuity over time, usually as a sweep over a limited part (subset) of the bandwidth (exp(j·2π·f·t), with f sweeping linearly from a starting frequency (f1) to an ending frequency (f2) over the SS. In this way, a given number of cycles may occur at an increasing or decreasing speed in a given range over a circle in the IQ-domain. This ideal choice ensures PAPR=0 dB at digital level, and allows top-class waveforms (almost constant envelope) signals even after usual low-pass filtering effects, but without requiring the complex low-pass smoothing/filtering and related drawbacks of traditional PSK modulations.

In one embodiment, to modulate the information bits, a slope direction (equivalent to a conjugate/flip of the SS sequence) can be used to encode a first bit of the information bits, and a coarse frequency-shift (starting frequency) used to encode a plurality of bits (e.g., N) of the information bits. Other embodiments may optionally use only one of these features to encode one or more information bits. In embodiments, N can be chosen sufficiently low compared to the frequency resolution over the available bandwidth, to easily discriminate the frequency-shifts at receivers with any considered multipath channel and offset impairment.

In an embodiment, recipes such as described above can be applied on this extended/repeated sequence for robustness and PIM. In one embodiment, the recipe may be determined based at least in part on a Group ID and its length, generally associated with a given Range. Note that scalability in Range, rate, and Group is still possible, and further, additional PIM capabilities can be realized by considering several SS slopes respecting the rules (e.g., several f2 options, depending on the Group ID).

In one embodiment of a M2 implementation, information modulation is performed with a known expected SS basis (including signal slope, and N allowed frequency-offsets f1(i)), and a given recipe). To modulate 1+log₂(N) bits of information, direction of the slope (slope*±1) is used for a first bit, and a selected frequency-offset (among N) is used to modulate N bit(s).

With this modulation implementation, there are fewer discontinuities (and generally continuous phase modulation), realizing improved signal shaping and spectrum by a transmitter. And for a receiver, there can be simplifications and useful processing by ‘unsloping’, correlating a signal portion by a SS (equivalent to slope) and its conjugate (equivalent to slope in the other direction), to easily discriminate a potential SS basis and direction (versus noise and interferers) and determine its frequency offset, after an FFT. Stated another way, a receiver can readily distinguish signals by performing a simple correlation/FFT and energy aggregation. Such operations are performed for 1 SS, then doing the same operations on the different repetitions ‘un-reciped,’ and smartly recombing the related soft-estimations of most probable symbol-values, considering channel characteristics and interference that may be estimated at receivers. In this way, embodiments may provide top-class performance without extra iterative or very complex processing.

In one example of this M2 information modulation, a number of SS samples may be determined based on a Range, which may be, e.g., {32,64, 128,256, . . . } samples. In turn, a SME may be formed of a given number of SS repetitions, e.g., L={4,6, etc.}. A Group can be used to select a Recipe over the L repetitions. This Recipe may include several SS slopes, and may include basic operations like +/−slope (1 b), frequency-shifts (e.g., 4 b to divide the bandwidth in 16 offsets), and/or optional phase shifts.

In an embodiment, there may be, e.g., 4 or 8 slopes with good properties and phase continuity on edges to define the SS-basis subset between f1 and f2. And in an embodiment there may be up to 8*M^{2L} recipes/groups, if M potential operations per SS repetition are considered for the recipe vector over 2 SME symbols. In one embodiment, information modulation may encode 4 bits per SME, considering 16 potential values for data modulation at a given MCS. There can be 2 potential slope-directions (1 bit to reverse the signal direction of each SS)*8 potential frequency-shifts over the bandwidth (3 bits). Note that the frequency-shifts are circular over the potential offsets over the bandwidth (e.g., [−4:+3]*x for the 8 potential frequency-shifts of the SS[0:f2]).

With a transmitter performing modulation in accordance with an embodiment, improved performance may be realized while reducing receiver complexity. In general, a receiver in accordance with an embodiment may be configured with one or more correlators to correlate a received signal with an expected sequence and its complex conjugate {sequence and (conj(sequence)}. Based on the correlation, a significant aggregation of energy (accumulating on a same phase) will occur for the correlation of at most one of these sequences, if an equivalent sequence (having substantially the same slope) exists in the signal. The other correlation will mainly aggregate noise (this will also give a reference).

Based at least in part on this correlation operation, a first information bit, which may be encoded in a slope of the sequence {seq or conj(seq)} can be identified. To the extent that the sequence in the signal may have been shifted prior to transmission (to modulate more information with frequency offsets), it is not directly an aggregation of the same value but more a continuous wave (CW) (complex sine wave corresponding to the frequency offset). In embodiments, the receiver can readily identify this signal by performing a FFT on these correlations. After FFT processing, a frequency-offset among the allowed offsets can be determined by a simple power aggregation/evaluation over subsets of the FFT output to identify one or more additional information bits. The combination of the frequency offset, and any other time-offsets in the wireless channel (including multipath channel with echoes) may add some bins appearing at the output of this FFT. The receiver in turn can directly read the channel characteristics from this FFT output and see this combined offset (and with the designed preamble, as the initial time reference offset is known/synchronized, areas of frequency offsets among the possible allowed offsets of the modulation can be determined without stringent synchronization accuracy).

The receiver may perform such processing for several repetitions (extended recipes), and knowing the Recipe of operations, robustness increases, as there are several soft estimates of probability in very noisy and interfered environments. In addition, relative information like powers over repetitions also provides useful information. Based at least in part on such information, the receiver can smartly recombine these several estimates to make a final estimate (or decision). More particularly, in certain embodiments a receiver may be configured to determine a soft decision, to enable better performance in FEC processing following the channel decoder. In this way, a receiver can process incoming extended and modulated symbols in a manner that is natively robust to any multipath channel and interference, with good signatures to identify, while avoiding complex additional receiver processing to handle these impairments. If phase-shifts are not part of the Recipe of operations, a simple non-coherent receiver with energy aggregation can be used to discriminate all groups at the same time; otherwise, similar groups with only different phases would appear as equivalent. If the extra phase-shift information is used at the receiver, better performance may be achieved using a coherent receiver while allowing discrimination of more groups if these extra degrees of freedom are also in the transmitter recipes. This is an extra trade-off in network designs based on this modulation. If the extra phase-shift information is used at the receiver, better performance may be achieved using a coherent receiver.

In general, a transmitter may perform modulation using any given sequence, over several samples (generally close to a frequency sweep, although other sequences could be considered). Such sequences may have a continuity of phase at their edges, to aid in having a good final spectrum shaping over a packet without extra low pass filtering or smoothing.

Note that the sequences described herein may be formed from samples of a digital baseband signal, implemented as a vector of complex (IQ) samples, i.e., values (I+jQ) over time. Each sample can be seen in a 2D-space (I vs Q), and also represented after polar conversion in module R and phase P: Z=I+jQ=R·exp(jP). With a constant modulus, the signal is like a phase varying over time, i.e., successive points over a unit circle in the 2D-space I-Q plane. The more quickly that the phase varies, the higher is the frequency (as frequency is the derivative of the phase), as described in the GCS equation in paragraph 31 above.

If the sweep sequence is a block of N=128 samples for instance, and assuming concatenating such blocks, for maintaining good properties and a continuous signal, the end of the sweep sequence is ideally continuous with the beginning of such sequence in phase (i.e., continuity at first order, while continuity in frequency would be at second order mathematically), to ensure this circular continuity of the signal. For instance, this is the case if S_GCS(N+1)=S_GCS(1) considering Recipes that do not invert the starting phase one symbol over two. When looking at the signal over time, it appears to be continuous without unexpected big change in variations of phase/frequency. The signal sweeps slowly, and then could be generated by direct-phase modulators, in some embodiments, may be more efficient, and operate at lower power consumption.

In some embodiments, an integer number of cycles (over the I-Q circle) over a sweep sequence may be used to ensure that the sequence arrives at the same point at the end of the sequence as the point at the beginning. Using that arrangement, a given number of combinations of parameters {N,Q,U} case be used while being in a targeted range of fmin/fmax.

As described above, a sequence can be defined at baseband frequency as a vector of complex (R+jI) values. A sequence (including its length and slope) can be selected from a plurality of sequences based, at least in part, on a Range and/or Group associated with the user/packet. This selection of a given sequence may improve network efficiency, and scaling, effectively allowing several groups to concurrently communicate within the network.

Once a sequence is selected, it is extended to a plurality of repetitions, which aid in robustness, and in combination with Recipe of operations, to handle noises, interferences, and multiple-access without losing colliding packets. In general, the greater the Range (having a lower signal-to-interference plus noise (SINR)), the longer the length. In various embodiments, Groups may also be associated with lengths, slope bases and/or Recipes as described below. The number or repetitions may generally increase with the Range and the number of required Groups (global scaling, both in Range and Groups).

Over a set of repeated sequences (e.g., L repeated sequences), a Recipe of operations is applied. Stated another way, a vector of operations may be used, (e.g., L′ operations for L sequences), where each operation can be a combination of one or more basic operations selected from one or more of: complex-conjugate S*(n); flip-sequence (a time-reversal S(−n)); phase-shift S·exp(j·P); frequency-shift S·exp(j·2pi·Df·n), circular-timeshift S(n-Dt) and/or potentially slopes of sequences S·exp(j·2pi·Ds·n²). For example, a symbol may be spread over L′ SS, where L′>L, with L=4 or 6 being the number of repetitions to form a SME; while L′ could be 8, 12, 16 or any other value for recipes. Depending on implementation, one or more of these basic operations can be used to modulate the information to transmit (data bits), and one or more of these basic operations can be selected based, at least in part, on packet interference mitigation information, to distinguish among users.

For modulation M1 as discussed above, a circular-timeshift is used for data modulation, and is first applied. Then, other degrees of freedom (e.g., complex-conjugate, flip-sequence, Phase-shift, and/or Frequency-shift) can be used to apply Recipes of operations over repetitions based, at least in part, on Group/PIM information.

For modulation M2 a complex-conjugate/flip and/or a frequency-shift (among a subset of allowed coarse shifts) can be used for data modulation and is applied first. Then, other degrees of freedom (e.g., extra complex-conjugate over repetitions, extra frequency-shift over repetitions, phase-shifts, circular-timeshift, and/or potentially small adjustment in slope of the sequence) can be used to apply Recipes of operations over repetitions based, at least in part, on Group/PIM information. More generally, a first bit is mapped to a given operation (known at transmitter and receiver) among all the possible operations of Recipes. This basic operation, in embodiments, could be conj(S) or flip(S) or flip(conj(S)) of the sequence S. Flip(conj) ensures phase continuity while using the same bandwidth and being equivalent to the “reversed-slope”. With embodiments, modulation and Group recipes are based on combinations from the same list of possible operations (e.g., conj, flip, frequency offsets, phase offsets).

In some cases, a default waveform with full signal continuity in phase and frequency over a sequence may be used even after modulation (especially if not using phase-shift or circular-timeshift operations for a minimal number of groups). Such waveform leads to very good shaping in time and frequency without extra processing/filtering. This waveform may also lead to easier receiver processing with continuity over each sequence and simpler aggregation of power for each sequence part.

With modulations in accordance with embodiments, a receiver can readily lock onto a given transmitter, and avoid being too disturbed by other transmitters that are (not fully orthogonal but) sufficiently different to be discriminated. As an analogy, each sequence/user has its own tone, like peoples' voices, such that several people can talk at the same time in the same room, and a listener can still understand and listen to a given person. Continuing this analogy, some words/modulation operations are used to transmit information, while other degrees of freedom included in the voice-tone and signature are used to discriminate users. Having many samples per bit enables low-rate long-range communication with a sufficient bandwidth, by leveraging the above-described degrees of freedom.

In operations, these various degrees of freedom can be used for given objectives/applications, considering all parameters/requirements and impairments of a given wireless resource/network. Embodiments that can flexibly select degrees of freedom for good scalability and flexibility between occupied bandwidth (e.g., slopes*number of frequency-offsets) and sampling frequency (corresponding to maximum bandwidth).

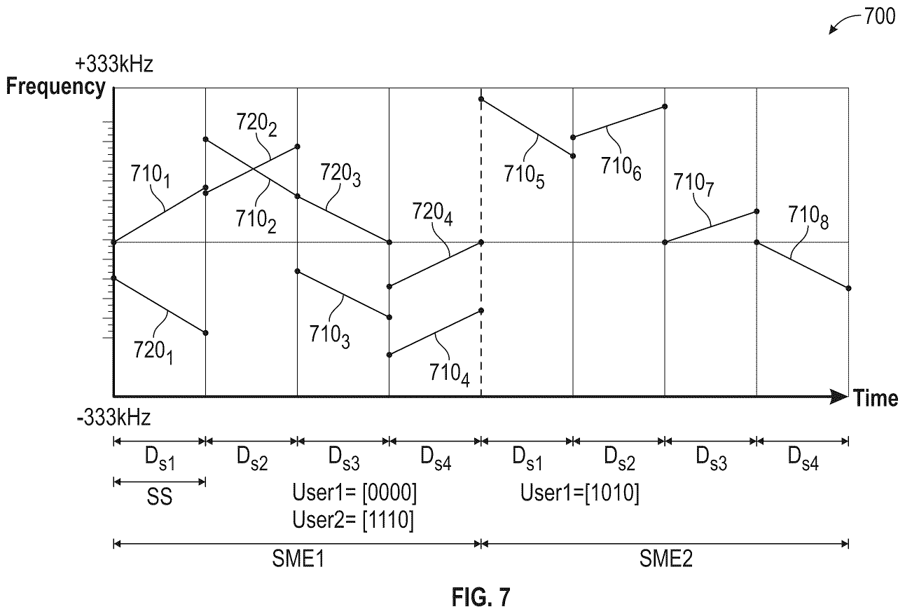

Referring now to FIG. 7, shown is a timing diagram illustrating modulation of information bits in accordance with another embodiment. As shown in FIG. 7, two users are communicating separate sequences. More specifically as shown in timing illustration 700, there are two users that are concurrently communicating with a receiver. As shown, the first user transmits a plurality of symbols, namely symbols 710₁₋₈, which are extended and modulated symbols as described herein. During a first SME (SME1), the first user transmits four extended and modulated symbols as sweep sequences 710₁₋₄. As seen, the first user sends a first repeated sweep sequence having given slope and frequency offsets to modulate a first set of information bits, namely the four bits [0000] shown in FIG. 7. In a particular embodiment, the slope of sequence 710₁ provides a first bit of information, e.g., a most significant bit (MSB), while a frequency offset of sequence 710₁ provides 3 bits of information, e.g., the three least significant bits (LSB's). More generally, for ‘M2’ modulation, one information bit is used to select the ‘sequence-mode’ basis, roughly its slope (e.g., selecting between 2 low-interfering sequences on the same bandwidth, e.g., between S and flip(conj(S))). And three information bits are used to select the frequency-offset basis (in this example, 2³=8 offsets). Note that any reference could be chosen for the value zero; in FIG. 7 it is shown to be in the center of the frequency spectrum, but it could be the lower point or anything else, and it is circular over the bandwidth.

Still with reference to FIG. 7 for a first SME, the second user sends a second repeated sweep sequence having given slope and frequency offsets to modulate a second set of information bits, namely the four bits [1110] shown in FIG. 7. Note that even if users are represented “time-aligned” in FIG. 7, it is generally not the case, and the principle still applies for non-synchronized users where each one has a specific signature through its specific Recipe.

Then in a second SME, the first user sends another repeated sweep sequence having slope and frequency offsets to modulate a second set of information, namely four additional bits ([1010]), using the same ‘M2’ modulation scheme described above.

Note that additional degrees of freedom reflected in the Recipe of operations performed on extended and modulated symbols 710₁₋₄ (for example) may be used to provide PIM. Stated another way, one or more additional basic operations of a Recipe of operations may be performed on top of the base sequence (frequency offset sequence). Such operations may include extra reversing slope and extra offsets, over each Ds, depending on the Group Recipe. By using various Recipe of operations, the signal can be spread over the full bandwidth. As an example, assuming 8 potential frequency offsets, each one of these offsets can be explored over 8 consecutive modulated symbols (Ds). In various implementations, there can be 8 or 12, 16 or 24 Recipe vectors, such that use of a given Recipe vector repeats every 8 or 12, 16 or 24 Ds. In addition, depending on Range/rate, there can be different numbers of repeated modulated symbols per SME. For example, while FIG. 7 shows a use case with 4 Ds per SME, in another example, there can be 6 Ds per SME, depending on a desired tradeoff between throughput and robustness.

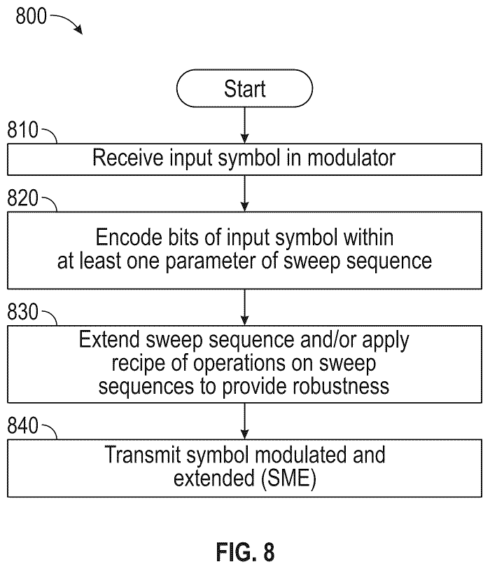

Referring now to FIG. 8, shown is a flow diagram of a method in accordance with another embodiment. More specifically, method 800 of FIG. 8 is a high-level method for modulating information using a modulation scheme as described herein. Method 800 may be performed, at least in part, using a controller or other processor of a wireless device that performs modulation based on various information parameters, including at least Group and/or Range information, along with other PIM parameters. To this end, the controller may perform method 800 alone and/or in combination with firmware and/or software. In such embodiments, the controller is configured to execute instructions stored in one or more non-transitory storage media.

As illustrated, method 800 begins by receiving an input symbol in a modulator (block 810). In an embodiment, this input symbol may be a symbol having been encoded in an encoder, and may encode one or more information bits. Next at block 820, such information bits of the input symbol may be encoded within at least one parameter of a selected sequence, which in various embodiments may be a sweep sequence.

Then at block 830, this sweep sequence can be extended, e.g., repeated a given number of times. In addition, a Recipe of operations may be applied on the sweep sequences to provide robustness. For example, a selected combination of basic operations can be performed on each repetition of the sweep sequence. As described herein, in some implementations each of these different repetitions may have a different Recipe vector of operations performed thereon, e.g., a different combination of basic operations. At this point, a symbol modulated and extended (SME) is thus realized. In turn, this SME can be transmitted via a RF front end circuit of the transmitter, at block 840. Although shown at this high level in the embodiment of FIG. 8, many variations and alternatives are possible. Note that FIG. 8 is agnostic as to the specific type of modulation that is performed. Depending on use case, a given one of M1 or M2-type modulations, for example, may be performed.

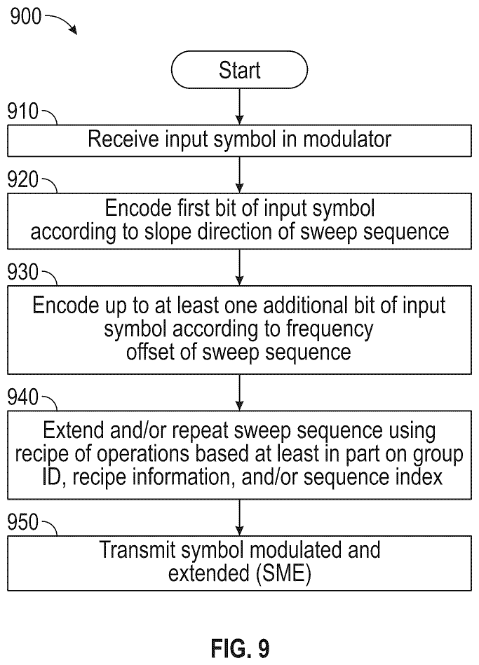

Referring now to FIG. 9, shown is a flow diagram of a method in accordance with yet another embodiment. More specifically, method 900 of FIG. 9 is a high-level method for modulating information using an alternate modulation scheme as described herein. Method 900 may be performed, at least in part, using a controller or other processor of a wireless device that performs a M2-based modulation as described herein.

As shown, method 900 begins by receiving an input symbol in a modulator (block 910), similar to that described above at block 810. Next at optional block 920, a first information bit of the input symbol may be encoded according to a slope direction of a selected sequence, e.g., a sweep sequence. More generally, this slope direction can be considered to be a flip or conjugate operation on the sequence. In cases, this first information bit may be any bit of rearranged bits (of an interleaving) when transmitter and receiver know position in symbol. Note that block 920 is illustrated in dashed form, as it may be optional in some implementations. That is, a given modulation scheme may not include any modulation of information bits according to slope or similar conjugate operations.

Still referring to FIG. 9, next at optional block 930, at least one additional information bit of the input symbol may be encoded according to a frequency offset of the sequence. For example with reference back to FIG. 7, the frequency offset can encode 3 information bits. Block 930 also is illustrated in dashed form, as it may be optional in some implementations. That is, a given modulation scheme may not include any modulation of information bits according to frequency offsets.

Then at block 940, this sweep sequence can be extended, e.g., repeated a given number of times. In addition, a Recipe of operations can be applied on the resulting extended sweep sequences to provide robustness. For example, a selected combination of basic operations can be performed on each repetition of the sweep sequence. As described herein, in some implementations each of these different repetitions may have a different Recipe vector of operations performed thereon, which may be selected based, at least in part, on one or more of a Group ID, recipe information, and/or a sequence index. At this point, a SME is formed, which is then transmitted via a RF front end circuit of the transmitter, at block 950. Although shown at this high level in the embodiment of FIG. 9, many variations and alternatives are possible.

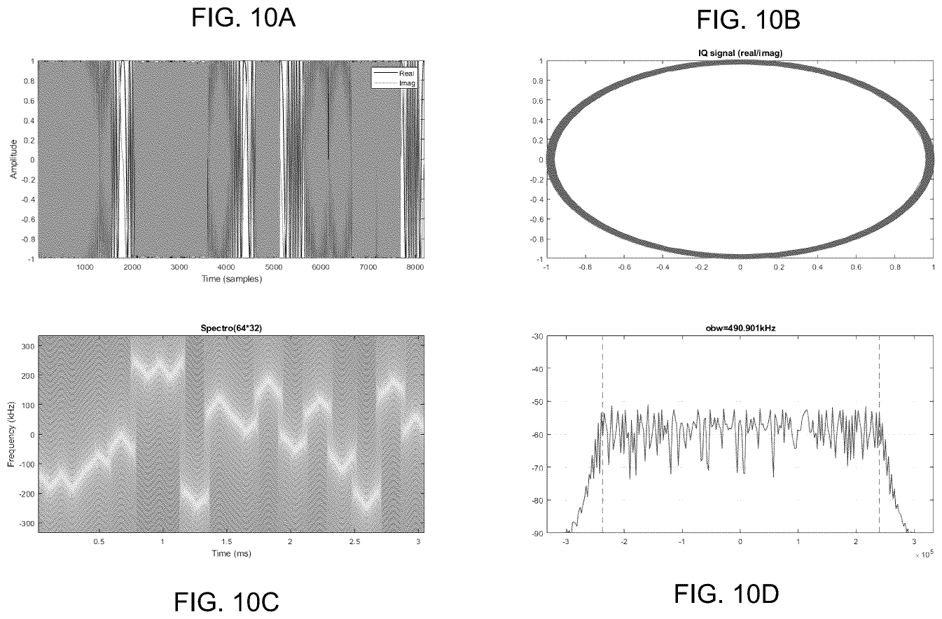

Referring now to FIGS. 10A-D, shown are examples of a signal generated with a M2 modulation in accordance with an embodiment. As shown, a given combination of slopes and frequency offsets provides very good shaping/capabilities for transmission and reception. FIG. 10C illustrates a spectrogram of time vs. frequency (but does not show dimensions of power (which is constant) and phase (which is designed to be continuous), that provides an optimal waveform. FIG. 10D is the related spectrum (power in the frequency domain), and FIG. 10A is real (I) and imaginary (Q) signals over time, and FIG. 10B is an illustration of real (I) vs. imaginary (Q) portions of the signal, showing that the signal is constant in power (constant envelope=perfect circle) over time, for efficient low-power amplification.

With embodiments having variations containing a combination of recipes and modulation, a receiver, knowing the recipe, can find the modulated symbols. And with embodiments, there may be different options to split variations among modulation of information (coded) bits and recipes for robustness and PIM.

There can be hundreds or thousands of complex samples per SME as input degrees of freedom to define waveforms, for only some (e.g., 3, 4, 5) information bits to transmit per SME. This huge space of combinations can be constrained to signals having constant-envelope, good spectrum (implies slow variations/phase continuity), easy to modulate and demodulate (e.g., choice of piecewise linear frequency sweeps, i.e., seq G=exp(j·(P+2pi·Q/N·n+pi·U/N²·n²)), n=[0 . . . N], and with good capabilities to find different waveforms (from recipes) among different groups of users that do not interfere too much (even if not aligned).

In some embodiments, machine learning and/or artificial intelligence techniques may be used to optimize this search space. As one particular example of constraining this pace, SME may be formed that is a combination of the above equation with only 4 repetitions varying Q and U (and optionally P for continuity at edges) in reasonable range, and a reasonable number of groups (e.g., 64-set sequences) with sub-sequences SS of length N=64, and may be used for either or both of M1 and M2 modulations described above.

In FIGS. 10A-D, a typical signal is shown trying several combinations of sequences (e.g., U in +/−{4,6}) and 8 frequency offsets). These signals may be defined at: oversampling (ovs)=4 (for L1=64 here); Fs0=666 kHz (Fs=ovs*Fs0) (scaling is possible); Df=6; Dr=Df (when slope negative); frequency offsets Q in [−3: +4]*Df (as would be used for modulation); and slopes U in [−6, −4, +4, +6] (to cover all cases for all groups as an example). Of course, other examples are possible.

While FIGS. 10A-D explore several possible U and Q to show related signals and spectrums, understand that in actual use cases, there may be a variation over time depending on both modulated symbols and recipes, such as NCO=Q·Df+Dr for modulation (and extra RECf(I) for recipes), and slope=U*(+/−1) for recipes.

Note that the signal vector can be defined either as a frequency vector, a phase vector, or an IQ-sample vector (or even a frequency-domain vector of OFDM-symbols as FFT is bijective complex-linear transformation). Moreover, the frequency area to define the SS basis is reduced, which can be defined on a limited number of subcarriers. A constant-envelope signal (here defined oversampled at the transmitter, optimizes shaping with proper constant-amplitude interpolation instead of low-pass filtering interpolation that would degrade shaping). Several modulations are possible, with ultra-low-power generation capabilities to provide a waveform having a very good spectrum, even before any low-pass filtering. The bandwidth may be limited, e.g., almost rectangular with very low out-of-band energy. The waveform may also have low sensitivity to any potential extra processing like usual low-pass filters (or any other TX/RX RF processing).

Note that waveform shaping in accordance with an embodiment results from considerations on modulation and recipes. In this regard, there are no phase jumps over time (continuous phase, contrary to usual PSK/QAM modulations), just some sparse limited frequency-offsets among expected values (e.g., 8 offsets to modulate 3 bits of information at each SME, with potential offsets at each SS depending on recipe for a given GroupID), and linear frequency variation over time depending on the slope (e.g., 4 potential slopes from the GroupID and potential inversion to modulate 1 more information bit at each SME).

In embodiments, extra smoothing/shaping at SS edges is also possible without degrading performance (such as samples at edges, e.g., 4 or 8 over the L1=64 samples per SS, are discarded at receiver processing to be robust to multipath channels or synchronization/filtering issues).

In one or more embodiments, a receiver for handling incoming M2-modulated signals can be configured to perform a simple correlation by an expected sequence and its conjugate, followed by an FFT. That way, it can discriminate the result to a given one of: an expected sequence, its potential conjugate to code a bit, or nothing/noise. Also, after the FFT, the receiver can determine a frequency-offset among allowed offsets, by performing a simple power aggregation/evaluation over subsets of the FFT output. Such receiver may be very robust as relative powers over areas of the FFT allow easy soft-information evaluation to provide to a decoder, while allowing large multipath channels offsets and other usual impairments of low-cost low-power devices, without complex extra processing or performance degradation. In some embodiments, if phase-shift is not used at a receiver, a simple non-coherent receiver with absolute value energy aggregation can be used. If phase-shift information is used at receiver, a coherent receiver may be used for better performance (providing a tradeoff of scalable performance vs. receiver complexity).

With embodiments, a single radio receiver can listen and demodulate several nodes at the same time, more easily and without losing too many packets or requiring too complex switching to handle nodes sharing a channel access. In this way, improved multiple-access and decoding of several asynchronous signals can occur. In one use case, for a given Range, 4 slope bases can be used in the uplink and downlink directions, providing at most 8 parallel TRXdigital to cover all.

Embodiments may also provide upper-layer optimizations such as error mitigation techniques to enhance the global network capacity and improve device sensitivity, using extra diversity from each retransmission. Briefly, in addition to spatial diversity of different gateways communicating with a given node, retransmission of a packet (or chunks, i.e., blocks of coded symbols) can bring extra time and frequency diversity at the receiver. For example, at retransmissions changes to a parameter like GroupID subpart or symbol index offset or scrambling seed can occur to obtain different channel coefficients for the symbols. To this end, a scrambling seed (as a SubGroupID equivalent to a retransmission counter) can be changed between retransmissions (and/or changing subgroup, adding a symbol offset). By changing the scrambling seed, simple receiver processing of each chunk can occur, and soft-bits of each reception can be combined to further optimize performance and device sensitivity. Indeed, just changing a scrambling ID with M2 modulation, alters the frequency offset of each symbol, introducing additional diversity. Such diversity can benefit the receiver to improve sensitivity after multiple receptions (complete or partial with some chunks retransmitted). With this arrangement, for the same bits of information before scrambling, different bits exist after scrambling and then different symbols and offsets. Thus if some parts of the band were affected (by multipath channel fading or interferences) destroying some bits, it will not be the case for the retransmission (fading on other bits), improving performance through diversity.

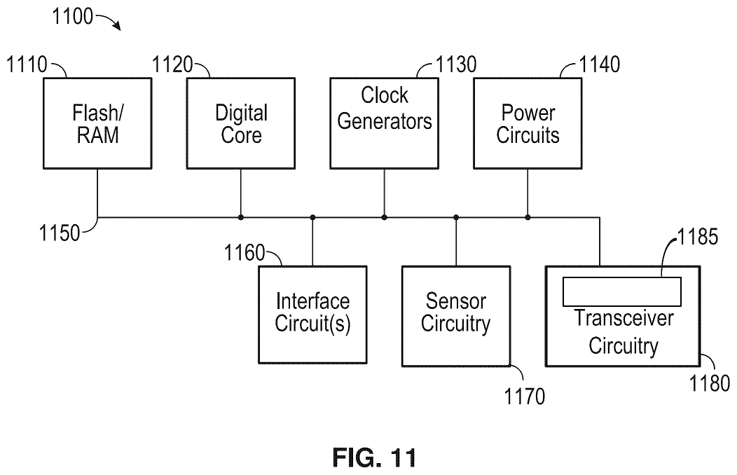

Embodiments may be incorporated into many different types of wireless systems. Referring now to FIG. 11, shown is a block diagram of a representative integrated circuit 1100 that includes transceiver circuitry to perform SWAM modulation and/or demodulation as described herein. In the embodiment shown in FIG. 11, integrated circuit 1100 may be, e.g., a microcontroller, wireless transceiver that may operate according to one or more wireless protocols (e.g., WLAN-OFDM, WLAN-DSSS, Bluetooth, 802.15.4, among others), or other device that can be used in a variety of use cases, including sensing, metering, monitoring, embedded applications, communications, applications and so forth, and which may be particularly adapted for use in an IoT device, particularly over longer ranges and in simultaneous user contexts.

In the embodiment shown, integrated circuit 1100 includes a memory system 1110 which in an embodiment may include a non-volatile memory such as a flash memory and volatile storage, such as RAM. In an embodiment, this non-volatile memory may be implemented as a non-transitory storage medium that can store instructions and data. Such non-volatile memory may store instructions, including instructions for transmitting and receiving packets having SWAM modulation characteristics as described herein.

Memory system 1110 couples via a bus 1150 to a digital core 1120, which may include one or more cores and/or microcontrollers that act as a main processing unit of the integrated circuit. In turn, digital core 1120 may couple to clock generators 1130 which may provide one or more phase locked loops or other clock generator circuitry to generate various clocks for use by circuitry of the IC.

As further illustrated, IC 1100 further includes power circuitry 1140, which may include one or more voltage regulators. Additional circuitry may optionally be present depending on particular implementation to provide various functionality and interaction with external devices. Such circuitry may include interface circuitry 1160 which may provide interface with various off-chip devices, sensor circuitry 1170 which may include various on-chip sensors including digital and analog sensors to sense desired signals, such as for a metering application or so forth.

In addition as shown in FIG. 11, transceiver circuitry 1180 may be provided to enable transmission and receipt of wireless signals according to one or more of a local area or wide area wireless communication scheme, including SWAM modulations as described herein. As shown, transceiver circuitry 1180 includes a PA 1185 that may transmit RF signals having packets formed of frames including modulated SMEs as described herein. Understand while shown with this high level view, many variations and alternatives are possible.

Note that ICs such as described herein may be implemented in a variety of different devices such as an IoT device. This IoT device may be a smart utility meter for use in a smart utility network, e.g., a network of stars or gateways in which long-range communication is according to an IEEE 802.15.4 specification or other such wireless protocol.

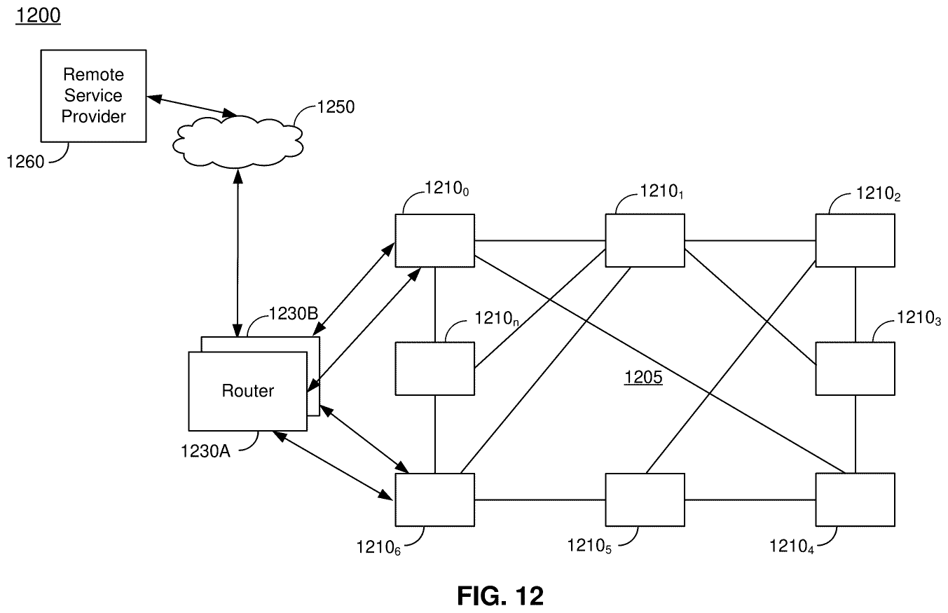

Referring now to FIG. 12, shown is a high level diagram of a network in accordance with an embodiment. As shown in FIG. 12, a network 1200 includes a variety of devices, including smart devices such as IoT devices, gateways/routers and remote service providers. In the embodiment of FIG. 12, a mesh network or network of stars 1205 may be present in a long range environment having multiple IoT devices 1210₀₋ₙ. Such IoT devices may generate and process packets having SME modulated symbols as described herein. As shown, at least one IoT device 1210 couples to one or more gateway(s) 1230 that in turn communicates with a remote service provider 1260 via a wide area network 1250, e.g., the internet. In an embodiment, remote service provider 1260 may be a backend server of a utility that handles communication with IoT devices 1210. Understand while shown at this high level in the embodiment of FIG. 12, many variations and alternatives are possible.

In embodiments, a sequence can be based on a linear frequency sweep to ease TX and RX processing. The modulation of the symbol with such a sequence can be based on applying simple operations on the sequence;

as a subset example, complex-conjugation (slope direction) and/or frequency-shift can be selected to efficiently code the information bits, instead of conventional amplitude or phase modulations, and another subset of operations can be used to perform the recipes over the multiple sequences, to obtain final packets with ideal signal waveforms and continuous phase variation, approximated by a second-order expansion with optimized phase trajectories to enhance both efficiency and robustness.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. An apparatus comprising:
an encoder to encode at least one information bit into a symbol of a packet;
a modulator coupled to the encoder, the modulator to:
apply at least one operation on a sequence to modulate the at least one information bit of the symbol, the sequence based, at least in part, on at least one of range information or group information of a plurality of information parameters;
a circuit coupled to the modulator, the circuit to:
extend the sequence to obtain at least one modulated symbol; and
perform, on the at least one modulated symbol, at least one additional operation according to a Recipe of operations, to obtain at least one extended and modulated symbol; and
a radio frequency (RF) front end circuit coupled to the circuit to process and transmit the at least one extended and modulated symbol.

2. The apparatus of claim 1, wherein the circuit is perform, on the at least one modulated symbol comprising a plurality of modulated symbols, the at least one additional operation according to the Recipe of operations based, at least in part, on the group information of the plurality of information parameters.

3. The apparatus of claim 1, wherein the modulator is to modulate at least a first bit of the at least one information bit in at least one of a parameter of the sequence or a frequency offset of the sequence.

4. The apparatus of claim 3, further comprising a controller to select the frequency offset based on the at least first bit.

5. The apparatus of claim 4, wherein the controller is to select the frequency offset from N frequency offsets, the at least first bit comprising log₂(N) bits.

6. The apparatus of claim 3, further comprising a controller to select the direction of the slope based on the at least first bit and to select the frequency offset based on one or more other bits of the at least one information bit.

7. The apparatus of claim 1, further comprising a controller to determine the Recipe of operations based, at least in part, on at least one of packet interference mitigation information or the group information of the plurality of information parameters.

8. The apparatus of claim 1, wherein the circuit is perform, on the at least one modulated symbol comprising a plurality of modulated symbols, the at least one additional operation comprising a combination of one or more of: a complex conjugate operation; a time reversal operation; a phase shift operation; a frequency shift operation; a circular time shift operation; or a slope operation.

9. An apparatus comprising:
a circuit to:
receive a symbol having at least one information bit;
encode at least a first bit of the at least one information bit in at least one of a direction of a slope of a sequence or a frequency offset of the sequence; and
perform, on the sequence, at least one operation according to a Recipe of operations, to obtain at least one modulated symbol; and
a radio frequency (RF) front end circuit coupled to the circuit to process and transmit the extended and modulated symbols.

10. The apparatus of claim 9, further comprising a controller coupled to the circuit, wherein the controller is to select the frequency offset based on the at least first bit.

11. The apparatus of claim 10, wherein the controller is to select the frequency offset from N frequency offsets, the at least first bit comprising log₂(N) bits.

12. The apparatus of claim 10, wherein the controller is to select the direction of the slope based on the first bit.

13. The apparatus of claim 10, wherein the controller is to determine the Recipe of operations based at least in part on at least one of packet interference mitigation information or group information of a plurality of information parameters.

14. The apparatus of claim 9, wherein the circuit is to extend the sequence to obtain a plurality of modulated symbols, and perform, on the plurality of modulated symbols, the at least one operation according to the Recipe of operations based, at least in part, on range information of a plurality of information parameters.

15. The apparatus of claim 9, wherein the circuit is to extend the sequence to obtain a plurality of modulated symbols, and perform, on the plurality of modulated symbols, the at least one operation according to the Recipe of operations based, at least in part, on at least one of packet interference mitigation information or group information of a plurality of information parameters.

16. The apparatus of claim 15, wherein the circuit is to perform, on the plurality of modulated symbols, the at least one operation comprising a frequency shift between a first one of the plurality of modulated symbols and a second one of the plurality of modulated symbols.

17. The apparatus of claim 9, wherein the Recipe of operations comprises at least one of:
a complex conjugate of at least one of the plurality of modulated symbols;
a phase operation on at least one of the plurality of modulated symbols;
a frequency shift of at least one of the plurality of modulated symbols; or
a time reversal of at least one of the plurality of modulated symbols.

18. A method comprising:
modulating, in a modulator of a transmitter, a symbol having at least one information bit, comprising performing at least one operation on a sequence, the sequence based, at least in part, on at least one of range information or group information of a plurality of information parameters;
extending, in a circuit of the transmitter coupled to the modulator, the sequence to obtain a plurality of modulated symbols;
performing, in the circuit, at least one additional operation on the plurality of modulated symbols according to a Recipe of operations, to obtain extended and modulated symbols; and
transmitting, via a radio frequency (RF) front end circuit of the transmitter coupled to the circuit, the extended and modulated symbols.

19. The method of claim 18, further comprising modulating at least a first bit of the at least one information bit in at least one of a direction of a slope of the sequence or a frequency offset of the sequence.

20. The method of claim 18, wherein modulating the symbol further comprises scrambling the symbol using a first scrambling seed, and the method further comprises:
modulating, in the modulator, the symbol scrambled using a second scrambling seed, comprising performing the at least one operation on a second sequence;
extending, in the circuit, the second sequence to obtain a second plurality of modulated symbols;
performing, in the circuit, the at least one additional operation on the second plurality of modulated symbols according to the Recipe of operations, to obtain second extended and modulated symbols; and
transmitting, via the RF front end circuit, the second extended and modulated symbols, to provide a retransmission of the symbol.
